(19) United States
(12) Patent Application Publication
(10) Pub. No.: US 2025/0071586 A1
(43) Pub. Date: Feb. 27, 2025

(54) REFERENCE SIGNAL MEASUREMENT METHOD AND APPARATUS, USER EQUIPMENT, NETWORK SIDE DEVICE AND STORAGE MEDIUM

(71) Applicant: BEIJING XIAOMI MOBILE SOFTWARE CO., LTD., Beijing (CN)

(72) Inventor: Yi XIONG, Beijing (CN)

(73) Assignee: BEIJING XIAOMI MOBILE SOFTWARE CO., LTD., Beijing (CN)

(21) Appl. No.: 18/687,811

(22) PCT Filed: Aug. 31, 2021
(86) PCT No.: PCT/CN2021/115725

§ 371 Date: Feb. 29, 2024

(51) Int. Cl. H04W 24/10; H04L 5/00; H04W 24/02

(52) U.S. Cl. CPC H04W 24/10; H04L 5/0051; H04W 24/02

(57) ABSTRACT

Provided are a reference signal measurement method and apparatus, a user equipment (UE), a network side device and a storage medium, which belong to the technical field of communications. The method includes: receiving configuration information sent by a network side device, the configuration information including a trigger condition corresponding to a frequency point to be measured and/or a trigger condition corresponding to a cell to be measured, and the trigger condition being used to trigger the update of the measurement configuration of the frequency point and/or the measurement configuration of the cell; sending an update request to the network side device on the basis of the trigger condition; receiving information sent by the network side device on the basis of the update request; and measuring the frequency point and/or the cell on the basis of the information.

### CROSS-REFERENCE

The present application is a U.S. National Stage of International Application No. PCT/CN2021/115725, filed on Aug. 31, 2021, the contents of which are incorporated herein by reference in their entireties for all purposes.

### TECHNICAL FIELD

The present disclosure relates to the field of communication technologies, and in particular to a method and apparatus for measuring a reference signal, a user equipment, a network side device and a storage medium.

### BACKGROUND

In 5G communication systems, the coverage of Non-Terrestrial Networks (NTN) cells generally includes some Terrestrial Networks (TN) cells. Due to a large transmission delay of the NTN cells, User equipment (UEs) will be preferentially handed over the TN cells as serving cells.

In the related arts, a network configures a connected UE with a measurement identity, a reporting configuration and a measurement object at a frequency where a TN cell is located, and the UE measures the TN cell based on the configuration by the network and hands over to the TN cell based on a measurement result.

### SUMMARY

The present disclosure provides a method and apparatus for measuring a reference signal, a user equipment, a network side device and a storage medium.

A method for measuring a reference signal provided by an aspect of embodiments of the present disclosure is applied to a UE and includes:
receiving configuration information sent by a network side device, wherein the configuration information includes a trigger condition corresponding to a frequency point to be measured and/or a trigger condition corresponding to a cell to be measured, and the trigger condition is configured to trigger an update of a measurement configuration of the frequency point to be measured and/or a measurement configuration of the cell to be measured;
sending an update request to the network side device based on the trigger condition;
receiving information sent, based on the update request, by the network side device; and
measuring the frequency point to be measured and/or the cell to be measured based on the information.

A method for measuring a reference signal provided by another aspect of embodiments of the present disclosure is applied to a network side device and includes:
sending configuration information to a UE, wherein the configuration information includes a trigger condition corresponding to a frequency point to be measured and/or a trigger condition corresponding to a cell to be measured, and the trigger condition is configured to trigger an update of a measurement configuration of the frequency point to be measured and/or a measurement configuration of the cell to be measured;
receiving an update request sent by the UE; and
sending information to the UE based on the update request.

A communication device provided by still another aspect of embodiments of the present disclosure includes a processor and a memory, wherein a computer program is stored in the memory, and the processor executes the computer program stored in the memory to cause the communication device to execute the method provided in the aspect of the above embodiments.

A communication device provided by still another aspect of embodiments of the present disclosure includes a processor and a memory, wherein a computer program is stored in the memory, and the processor executes the computer program stored in the memory to cause the communication device to execute the method provided in the other aspect of the above embodiments.

A communication device provided by still another aspect of embodiments of the present disclosure includes a processor and an interface circuit; and
wherein the interface circuit is configured to receive code instructions and transmit the code instructions to the processor; and
the processor is configured to run the code instructions to execute the method provided in the aspect of the above embodiments.

A communication device provided by still another aspect of embodiments of the present disclosure includes a processor and an interface circuit; and
wherein interface circuit is configured to receive code instructions and transmit the code instructions to the processor; and
the processor is configured to run the code instructions to execute the method provided in the other aspect of the above embodiments.

A computer-readable storage medium provided by still another aspect of embodiments of the present disclosure is configured to store instructions, wherein the instructions, when executed, cause the method provided in the aspect of the above embodiments.

A computer-readable storage medium provided by still another aspect of embodiments of the present disclosure is configured to store instructions, wherein the instructions, when executed, cause the method provided in the other aspect of the above embodiments.

### BRIEF DESCRIPTION OF THE DRAWINGS

The above and/or additional aspects and advantages of the present disclosure will become apparent and readily understood from the following description of embodiments with reference to the accompanying drawings, in which:

FIG. 1A is a schematic diagram of a UE being located in an NTN cell provided by an embodiment of the present disclosure;

FIG. 1 is a schematic flowchart of a method for measuring a reference signal provided by an embodiment of the present disclosure;

FIG. 2 is a schematic flowchart of a method for measuring a reference signal provided by another embodiment of the present disclosure;

FIG. 3 is a schematic flowchart of a method for measuring a reference signal provided by yet another embodiment of the present disclosure;

FIG. 4 is a schematic flowchart of a method for measuring a reference signal provided by still another embodiment of the present disclosure;

FIG. 5 is a schematic flowchart of a method for measuring a reference signal provided by still another embodiment of the present disclosure;

FIG. 6 is a schematic flowchart of a method for measuring a reference signal provided by still another embodiment of the present disclosure;

FIG. 7 is a schematic flowchart of a method for measuring a reference signal provided by still another embodiment of the present disclosure;

FIG. 8 is a schematic structural diagram of an apparatus for measuring a reference signal provided by an embodiment of the present disclosure;

FIG. 9 is a schematic structural diagram of an apparatus for measuring a reference signal provided by another embodiment of the present disclosure;

FIG. 10 is a block diagram of a user equipment provided by an embodiment of the present disclosure; and

FIG. 11 is a block diagram of a base station provided by an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the embodiments of the present disclosure. Instead, they are merely examples of apparatuses and methods consistent with some aspects of embodiments of the present disclosure as recited in the appended claims.

The terms used in embodiments of the present disclosure are merely for the purpose of describing particular embodiments and are not intended to limit embodiments of the present disclosure. As used in embodiments of the present disclosure and the appended claims, the singular forms “a” and “the” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in embodiments of the present disclosure to describe various information, such information should not be limited to these terms. These terms are only used to distinguish the same type of information from each other. For example, without departing from the scope of embodiments of the present disclosure, the first indication information may also be referred to as the second information, and similarly, the second information may also be referred to as the first information. Depending on the context, the word “if” as used herein can be interpreted as “upon” or “when” or “in response to determination”.

As described above, in 5G communication systems, the coverage of Non-Terrestrial Networks (NTN) cells generally includes some Terrestrial Networks (TN) cells. Due to a large transmission delay of the NTN cells, User equipment (UEs) will be preferentially handed over the TN cells as serving cells.

In the related arts, a network configures a connected UE with a measurement identity, a reporting configuration and a measurement object at a frequency where a TN cell is located, and the UE measures the TN cell based on the configuration by the network and hands over to the TN cell based on a measurement result.

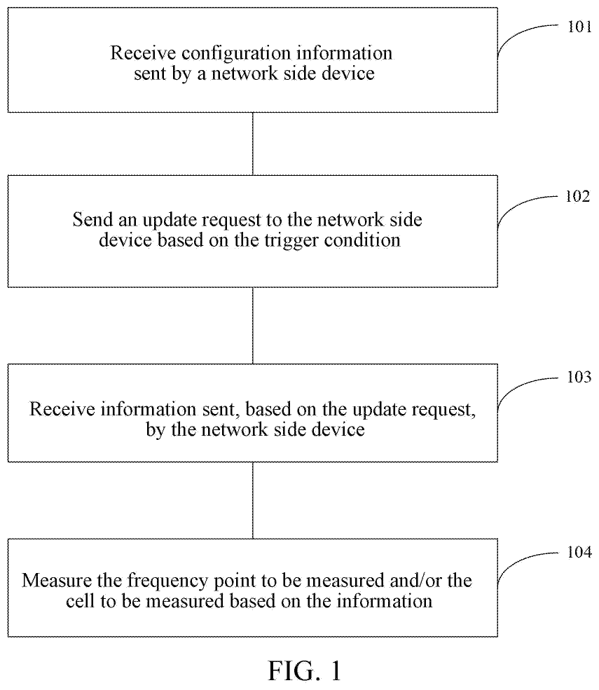

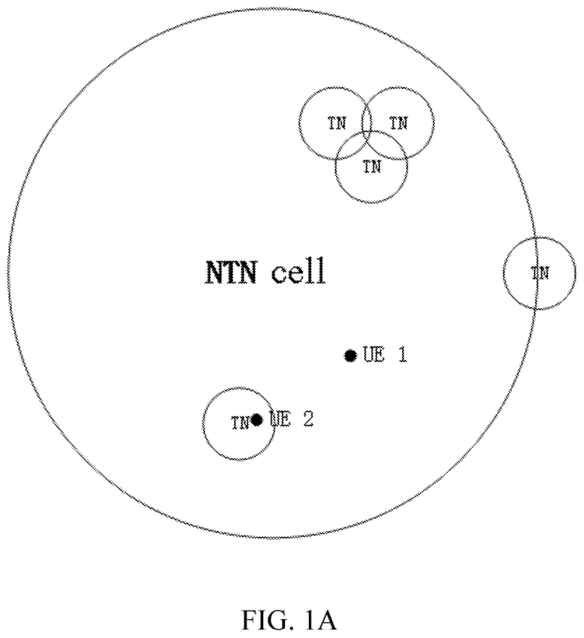

However, in the related arts, when there is no TN cell coverage near an area where the UE (such as a UE1 in FIG. 1A) is located, the UE will still always measure the TN cell, which will cause power consumption and increase the power consumption.

A method and apparatus for measuring a reference signal, a user equipment, a network side device and a storage medium provided by embodiments of the present disclosure are described in detail below with reference to the accompanying drawings.

FIG. 1 is a schematic flowchart of a method for measuring a reference signal provided by an embodiment of the present disclosure. The method is performed by a UE. As shown in FIG. 1, the method for measuring the reference signal may include steps 101 to 104.

In the step 101, configuration information sent by a network side device is received.

It should be noted that the method for measuring the reference signal in embodiments of the present disclosure can be applied to any UE. The UE may refer to a device that provides speech and/or data connectivity for the user. The UE may communicate with one or more core networks via a Radio Access Network (RAN). The UE may be an Internet of Things terminal, such as a sensor device, a mobile phone (or a “cellular” phone), and a computer having an Internet of Things terminal, for example, a fixed, portable, pocket-sized, handheld, computer built-in or vehicle-mounted device. For example, it may be a station (STA), a subscriber unit, a subscriber station, a mobile station, a mobile, a remote station, an access point, a remote terminal, an access terminal, a user terminal, or a user agent. Alternatively, the UE may also be a device of an unmanned aerial vehicle. Alternatively, the UE may also be an in-vehicle device, for example, a trip computer with a wireless communication function, or a wireless terminal external to the trip computer. Alternatively, the UE may also be a roadside device, for example, a street light, a signal light, or other roadside device with a wireless communication function, etc.

In an embodiment of the present disclosure, the network side device may include a base station or a core network entity.

In an embodiment of the present disclosure, the configuration information may specifically include a trigger condition corresponding to a frequency point to be measured and/or a trigger condition corresponding to a cell to be measured. In an embodiment of the present disclosure, the configuration information may only include the trigger condition corresponding to the frequency point to be measured. In another embodiment of the present disclosure, the configuration information may only include the trigger condition corresponding to the cell to be measured. In yet another embodiment of the present disclosure, the configuration information may include the trigger condition corresponding to the cell to be measured and the trigger condition corresponding to the frequency point to be measured.

In an embodiment of the present disclosure, the trigger condition corresponding to the frequency point to be measured may be configured to trigger an update of a measurement configuration of the frequency point to be measured. For example, in an embodiment of the present disclosure, a trigger condition of a frequency point to be measured A may be configured to trigger an update of a measurement configuration of the frequency point A to be measured.

In an embodiment of the present disclosure, the trigger condition corresponding to the cell to be measured may be configured to trigger an update of a measurement configuration of the cell to be measured. For example, in an embodiment of the present disclosure, a trigger condition of a cell to be measured B may be configured to trigger an update of a measurement configuration of the cell to be measured B.

In another embodiment of the present disclosure, the trigger condition corresponding to the frequency point to be measured may be configured to trigger an update of a measurement configuration of another frequency points to be measured. For example, in an embodiment of the present disclosure, the trigger condition of the frequency point to be measured A may be configured to trigger an update of a measurement configuration of a frequency point to be measured C.

In an embodiment of the present disclosure, the trigger condition corresponding to the cell to be measured may be configured to trigger an update of a measurement configuration of another cell to be measured. For example, in an embodiment of the present disclosure, the trigger condition of the cell to be measured B may be configured to trigger an update of a measurement configuration of a cell to be measured D.

It should be noted that in an embodiment of the present disclosure, the other frequency point/cell to be measured may be configured by the network. In another embodiment of the present disclosure, the other frequency point/cell to be measured may also be specified by a protocol. In yet another embodiment of the present disclosure, the other frequency point/cell to be measured may also be determined by the UE.

Further, in an embodiment of the present disclosure, the frequency point/cell to be measured configured by the network may be included in information sent by the network based on an update request (that is, information sent, based on the update request, by the network side device which is received by the UE in the subsequent step 103).

In an embodiment of the present disclosure, the frequency point to be measured may be a frequency point corresponding to any cell, and the cell to be measured may be any cell. For example, in an embodiment of the present disclosure, the frequency point to be measured may be a frequency point corresponding to a TN cell in a NTN cell, and the cell to be measured may be the TN cell in the NTN cell.

Further, in an embodiment of the present disclosure, the trigger condition corresponding to the cell to be measured may include at least one of:
the UE failing to detect a measurement reference signal of the cell to be measured;
the UE failing to detect a measurement reference signal of a frequency point corresponding to the cell to be measured;
the UE failing to obtain a measurement result of the cell to be measured; and
the UE measuring that a measurement result of the cell to be measured is less than a first threshold value.

It should be noted that in an embodiment of the present disclosure, the trigger condition corresponding to the cell to be measured may include any of the above items. In another embodiment of the present disclosure, the trigger condition corresponding to the cell to be measured may include a combination of the above any several items.

In an embodiment of the present disclosure, the above any several items may be combined using a logical relationship such as AND, OR, NOT, etc.

In an embodiment of the present disclosure, the trigger condition corresponding to the frequency point to be measured may include at least one of:
the UE failing to detect a measurement reference signal of a cell corresponding to the frequency point to be measured;
the UE failing to detect a measurement reference signal of the frequency point to be measured;
the UE failing to obtain a measurement result of the cell corresponding to the frequency point to be measured;
the UE measuring that the maximum value of measurement results of the frequency point to be measured is less than a second threshold value;
the UE measuring that the minimum value of the measurement results of the frequency point to be measured is less than a third threshold value; and
the UE measuring that an average value of the measurement results of the frequency point to be measured is less than a fourth threshold value.

In an embodiment of the present disclosure, the first threshold value, the second threshold value, the third threshold value and the fourth threshold value may be the same. In another embodiment of the present disclosure, the first threshold value, the second threshold value, the third threshold value and the fourth threshold value may be different.

In an embodiment of the present disclosure, the trigger condition corresponding to the frequency point to be measured may include any of the above items. In another embodiment of the present disclosure, the trigger condition corresponding to the frequency point to be measured may include a combination of the above any several items.

In an embodiment of the present disclosure, the above any several items may be combined by using the logical relationship such as AND, OR, NOT, etc.

In an embodiment of the present disclosure, the measurement reference signal may include but is not limited to one or more of:
a Synchronization Signal Block (SSB);
a Channel State Information-Reference Signal (CSI-RS); and
other reference signals that can be used for the measurement.

In an embodiment of the present disclosure, the measurement result includes but is not limited to one or more of:
a Reference Signal Received Power (RSRP);
a Reference Signal Received Quality (RSRQ); and
a Signal-to-Interference plus Noise Ratio (SINR).

In an embodiment of the present disclosure, the method for the UE to receive the configuration information sent by the network side device may include at least one of:
receiving the configuration information sent by the network side device through a system message;
receiving the configuration information sent by the network side device through a Radio Resource Control (RRC) message;
receiving the configuration information sent by the network side device through a Media Access Control Address Control Element (MAC CE) signaling; and
receiving the configuration information sent by the network side device through a Downlink Control Information (DCI) signaling.

In the step 102, an update request is sent to the network side device based on the trigger condition.

In an embodiment of the present disclosure, the method for the UE to send the update request to the network side device based on the trigger condition may include: determining whether the UE satisfies the trigger condition, and sending the update request to the network side device based on the determination result. It should be noted that, in an embodiment of the present disclosure, there is a correspondence between the determination result and the update request. Different determination results correspond to sending different update requests. The UE may determine the sent update request based on the correspondence and the determination result.

In an embodiment of the present disclosure, the correspondence between the determination result and the update request may include:
when the determination result is that the UE satisfies the trigger condition, it means that the UE is currently unable to detect the cell to be measured and/or the frequency point to be measured (that is, the UE is not within the coverage of the frequency point to be measured and/or the cell to be measured, or the UE is far from the cell to be measured and/or the frequency point to be measured). In this case, the UE may send to the network side device the update request for requesting to reduce a measurement opportunity, so as to reduce the measurement opportunity for the cell to be measured and/or the frequency point to be measured by the UE, preventing the UE from measuring the cell to be measured and/or the frequency point to be measured that cannot be measured by UE.

When the determination result is that the UE does not satisfy the trigger condition, it means that the UE is able to detect the cell to be measured and/or the frequency point to be measured (that is, the UE is close to the cell to be measured and/or the frequency point to be measured). In this case, the UE may send to the network side device an update request for requesting to increase the measurement opportunity or maintain the current measurement opportunity to maintain or increase the measurement opportunity for the cell to be measured and/or the frequency point to be measured by the UE, thereby ensuring that the UE can perform a normal measurement for the cell to be measured and/or the frequency point to be measured.

Regarding the method for obtaining the correspondence and a specific content included in the update request as mentioned above, detailed introduction will be given in subsequent embodiments.

In the step 103, information sent by the network side device based on the update request is received.

In an embodiment of the present disclosure, when update requests sent by the UE are different, content of information sent by the network side device based on the update requests will also vary.

Specifically, in an embodiment of the present disclosure, when the UE sends to the network side device the update request for requesting to reduce the measurement opportunity, the content included in the information sent by the network side device to the UE may be content that makes the UE reduce the measurement opportunity. In another embodiment of the present disclosure, when the UE sends to the network side device the update request for requesting to increase the measurement opportunity or maintain the current measurement opportunity, the content included in the information sent by the network side device to the UE may be content that makes the UE maintain the current measurement opportunity or increase the measurement opportunity.

In the step 104, the frequency point to be measured and/or the cell to be measured are measured based on the information.

In an embodiment of the present disclosure, the method for measuring the frequency point to be measured and/or the cell to be measured based on the information may include: measuring the frequency point to be measured and/or the cell to be measured based on the content included in the information.

As can be seen from the foregoing content, in an embodiment of the present disclosure, when the UE sends to the network side device the update request for requesting to reduce the measurement opportunity, the content included in the information received by the UE from the network side device is the content that enables the UE to reduce the measurement opportunity. Therefore, when the UE measures the frequency point to be measured and/or the cell to be measured based on the content, the measurement opportunity will be greatly reduced, which can prevent the UE from measuring the cell to be measured and/or the frequency point to be measured that cannot be measured by the UE, so as to reduce the power consumption.

In another embodiment of the present disclosure, when the UE sends to the network side device the update request for requesting to increase the measurement opportunity or maintain the current measurement opportunity, the content included in the information received by the UE from the network side device is content that enables the UE to maintain the current measurement opportunity or increase the measurement opportunity. Therefore, when the UE measures the frequency point to be measured and/or the cell to be measured based on the content, the measurement opportunity will be maintained or increased, which ensures that the UE performs the normal measurement for the cell to be measured and/or the frequency point to be measured, so that subsequent processes proceed normally.

Further, in an embodiment of the present disclosure, the information sent by the network side device to the UE may further include a valid duration and/or a valid time window. In an embodiment of the present disclosure, the valid duration and/or the valid time window may be specifically configured to indicate “a specific measurement time period in which the UE measures the frequency point to be measured and/or the cell to be measured based on the information sent by the network side device”. In an embodiment of the present disclosure, the UE may specifically measure, within the valid duration and/or the valid time window, the frequency point to be measured and/or the cell to be measured based on the content included in the information sent by the network side device, and measure, beyond the valid duration and/or the valid time window, the frequency point to be measured and/or the cell to be measured based on an original measurement configuration.

For example, in an embodiment of the present disclosure, it is assumed that the information sent by the network side device to the UE includes the valid duration, and the valid duration is ten minutes since the information sent by the network side device is received. Therefore, the UE may measure, within the ten minutes since receiving the information sent by the network side device, the frequency point to be measured and/or the cell to be measured based on the content of the information, and measure, beyond the ten minutes since receiving the information sent by the network side device, the frequency point to be measured and/or the cell to be measured based on the original measurement configuration.

To sum up, in the method for measuring the reference signal provided in the present disclosure, the UE receives the configuration information sent by the network side device, and the configuration information includes the trigger condition corresponding to the frequency point to be measured and/or the trigger condition corresponding to the cell to be measured, and then the UE sends the update request to the network side device based on the trigger condition, and receives the information sent, based on the update request, by the network side device. Finally, the UE measures the cell the frequency point to be measured and/or the cell to be measured based on the information sent by the network side device. In embodiments of the present disclosure, the UE sending the update request to the network side device based on the trigger condition is specifically: when the UE satisfies the trigger condition (i.e., the UE cannot measure the cell to be measured and/or the frequency point to be measured), the UE sends to the network side device the update request for requesting to reduce the measurement opportunity, so as to reduce the UE's measurement opportunity, which prevents the UE from measuring the cell to be measured and/or the frequency point to be measured that cannot be measured by the UE, thereby reducing the power consumption.

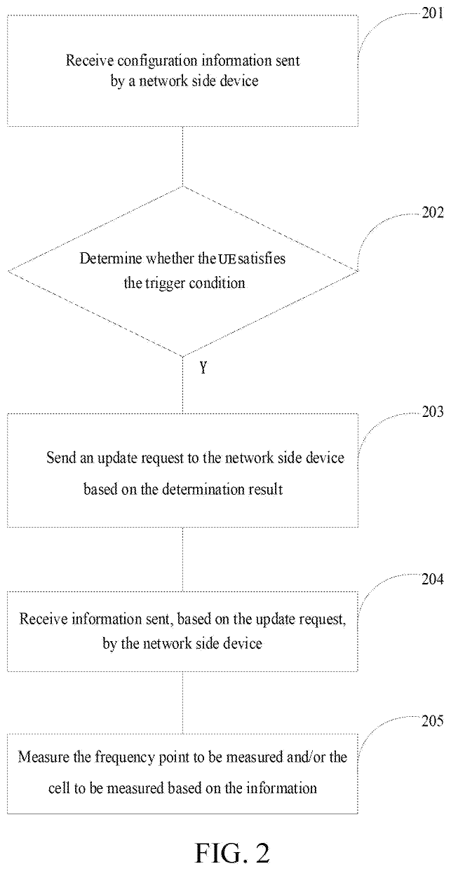

FIG. 2 is a schematic flowchart of a method for measuring a reference signal provided by an embodiment of the present disclosure. The method is performed by a UE. As shown in FIG. 2, the method for measuring the reference signal may include steps 201 to 205.

In the step 201, configuration information sent by a network side device is received.

In an embodiment of the present disclosure, the configuration information may include a trigger condition corresponding to a frequency point to be measured and/or a trigger condition corresponding to a cell to be measured, and the trigger condition is configured to trigger an update of a measurement configuration of the frequency point to be measured and/or a measurement configuration of the cell to be measured. For the detailed introduction related to the step 201, reference may be made to the above description, which is not repeated in embodiments of the present disclosure here.

In the step 202, it is determined whether the UE satisfies the trigger condition.

In an embodiment of the present disclosure, the method for determining whether the UE satisfies the trigger condition may include the following first step and second step.

In the first step, a predefined determination method is determined

In an embodiment of the present disclosure, the predefined determination method may include at least one of:
a first method: it is determined whether the UE satisfies the trigger condition based on the latest measurement (that is, it is determined whether, during the latest measurement, the UE cannot detect a measurement reference signal of the cell to be measured, and/or whether, during the latest measurement, the UE cannot detect a measurement reference signal of a frequency point corresponding to the cell to be measured, and/or whether, during the latest measurement, the UE cannot obtain a measurement result of the cell to be measured, and/or whether, during the latest measurement, the UE cannot detect a measurement reference signal of a cell corresponding to the frequency point to be measured, and/or whether, during the latest measurement, the UE cannot detect a measurement reference signal of the frequency point to be measured, and/or whether, during the latest measurement, the UE cannot obtain a measurement result of the cell corresponding to the frequency point to be measured).

A second method: it is determined whether the UE always satisfies the trigger condition in measurements within the most recent first duration (that is, it is determined whether, in the measurements within the most recent first duration, the UE always cannot detect the measurement reference signal of the cell to be measured, and/or whether, in the measurements within the most recent first duration, the UE always cannot detect a measurement reference signal of a frequency point corresponding to the cell to be measured, and/or whether, in the measurements within the most recent first duration, the UE always cannot obtain the measurement result of the cell to be measured, and/or whether, in the measurements within the most recent first duration, the UE always cannot detect the measurement reference signal of the cell corresponding to the frequency point to be measured, and/or whether, in the measurements within the most recent first duration, the UE always cannot detect the measurement reference signal of the frequency point to be measured, and/or whether, in the measurements within the most recent first duration, the UE always cannot obtain the measurement result of the cell corresponding to the frequency point to be measured).

A third method: it is determined whether the UE always satisfies the trigger condition in measurements within a first time window (that is, it is determined whether, in the measurements within the first time window, the UE always cannot detect the measurement reference signal of the cell to be measured, and/or whether, in the measurements within the first time window, the UE always cannot detect a measurement reference signal of a frequency point corresponding to the cell to be measured, and/or whether, in the measurements within the first time window, the UE always cannot obtain the measurement result of the cell to be measured, and/or whether, in the measurements within the first time window, the UE always cannot detect the measurement reference signal of the cell corresponding to the frequency point to be measured, and/or whether, in the measurements within the first time window, the UE always cannot detect the measurement reference signal of the frequency point to be measured, and/or whether, in the measurements within the first time window, the UE always cannot obtain the measurement result of the cell corresponding to the frequency point to be measured).

A fourth method: it is determined whether the UE always satisfies the trigger condition in the most recent first quantity of measurements (that is, it is determined whether, in the most recent first quantity of measurements, the UE always cannot detect the measurement reference signal of the cell to be measured, and/or whether, in the most recent first quantity of measurements, the UE always cannot detect a measurement reference signal of a frequency point corresponding to the cell to be measured, and/or whether, in the most recent first quantity of measurements, the UE always cannot obtain the measurement result of the cell to be measured, and/or whether, in the most recent first quantity of measurements, the UE always cannot detect the measurement reference signal of the cell corresponding to the frequency point to be measured, and/or whether, in the most recent first quantity of measurements, the UE always cannot detect the measurement reference signal of the frequency point to be measured, and/or whether, in the most recent first quantity of measurements, the UE always cannot obtain the measurement result of the cell corresponding to the frequency point to be measured).

It should be noted that in an embodiment of the present disclosure, the method for determining the first duration, the first time window and the first quantity as mentioned above may include at least one of:
performing determination based on a system message sent by the network side device;
performing the determination based on a RRC message sent by the network side device;
performing the determination based on a provision of a protocol;
independently performing the determination by the UE;
performing the determination based on a MAC CE signaling sent by the network side device; or
performing the determination based on a DCI signaling sent by the network side device.

In an embodiment of the present disclosure, a manner in which the UE determines the predefined determination method may include at least one of:
determining the predefined determination method based on an indication by the network side device (for example, the network side device indicates to determine the above second method as the predefined determination method);
determining the predefined determination method based on the provision of the protocol (for example, the above third method is determined as the predefined determination method based on the provision of the protocol); and
independently determining, by the UE, the predefined determination method (for example, the UE independently determines the above fourth method as the predefined determination method).

Further, in an embodiment of the present disclosure, the determined predefined determination method may include any of the above methods. In another embodiment of the present disclosure, the determined predefined determination method may include a combination of the above any several methods.

For example, in an embodiment of the present disclosure, if the network side device only configures the UE with the first duration, only the above second method may be determined as the predefined determination method. In another embodiment of the present disclosure, if the network side device configures the UE with the first duration and the first quantity, the UE can select one of the second method and the fourth method to be determined as the predefined determination method, or determine both second method and the fourth method as the predefined determination method.

In the second step, it is determined whether the UE satisfies the trigger condition based on the predefined determination method.

In an embodiment of the present disclosure, when predefined determination methods are different, processes of determining whether the UE satisfies the trigger condition are also different.

Specifically, in an embodiment of the present disclosure, if the above first method is determined as the predefined determination method, and the trigger condition is that the UE cannot detect the measurement reference signal of the cell to be measured, then a specific process of determining, based on the first method, whether the UE satisfies the trigger condition may be determining, in the latest measurement opportunity, whether the UE cannot detect the measurement reference signal of the frequency point to be measured, and when the UE cannot detect the measurement reference signal of the frequency point to be measured, the UE is considered to satisfy the trigger condition, otherwise, the UE is considered not to satisfy the trigger condition.

In another embodiment of the present disclosure, if the above second method is determined as the predefined determination method, and the trigger condition is that the UE cannot obtain the measurement result of the cell to be measured, then a specific process of determining, based on the second method, whether the UE satisfies the trigger condition may be determining, in all measurement opportunities within the most recent first duration, whether the UE always cannot obtain the measurement result of the cell to be measured, and when the UE always cannot obtain the measurement result of the cell to be measure within the most recent first duration, the UE is considered to satisfy the trigger condition, otherwise, the UE is considered not to satisfy the trigger condition.

In yet another embodiment of the present disclosure, if the above third method is determined as the predefined determination method, and the trigger condition is that the UE cannot obtain the measurement result of the cell to be measured, then a specific process of determining, based on the third method, whether the UE satisfies the trigger condition may be determining, in all measurement opportunities within the first time window, whether the UE always cannot obtain the measurement result of the cell to be measured, and when the UE always cannot obtain the measurement result of the cell to be measured within the first time window, the UE is considered to satisfy the trigger condition, otherwise, the UE is considered not to satisfy the trigger condition.

In still another embodiment of the present disclosure, if the above fourth method is determined as the predefined determination method, and the trigger condition is that the UE cannot detect the measurement reference signal of the frequency point corresponding to the cell to be measured, then a specific process of determining, based on the fourth method, whether the UE satisfies the trigger condition may be determining, in all of the most recent first quantity of measurement opportunities, whether the UE always cannot detect the measurement reference signal of the frequency point corresponding to the cell to be measured, and when the UE cannot detect the measurement reference signal of the frequency point corresponding to the cell to be measured in all of the most recent first quantity of measurement opportunities, the UE is considered to satisfy the trigger condition, otherwise, the UE is considered not to satisfy the trigger condition.

In the step 203, an update request is sent to the network side device based on the determination result.

In an embodiment of the present disclosure, the method for sending the update request to the network side device based on the determination result may include the following steps a and b.

In the step a, a correspondence between the determination result and the update request is determined.

In an embodiment of the present disclosure, the correspondence between the determination result and the update request may specifically include:
when the determination result is that the UE satisfies the trigger condition, the UE sends to the network side device an update request for requesting to reduce a measurement opportunity. In an embodiment of the present disclosure, the update request for requesting to reduce the measurement opportunity may include at least one of:
the UE satisfying the trigger condition;
a request to stop the measurement of the frequency point to be measured and/or the cell to be measured;
a request to reduce the measurement opportunity for the frequency point to be measured and/or the cell to be measured; and
a first parameter of the measurement configuration recommended by the UE, where the first parameter is more relaxed than an original parameter of the measurement configuration (for example, a Synchronization Signal Block Measurement Timing Configuration (SMTC) period corresponding to the original parameter is 5 ms, and a SMTC period corresponding to the first parameter may be 20 ms).

When the determination result is that the UE does not satisfy the trigger condition, the UE sends to the network side device an update request for requesting to increase the measurement opportunity or to maintain the current measurement opportunity. In an embodiment of the present disclosure, the update request for requesting to increase the measurement opportunity or to maintain the current measurement opportunity may include at least one of:
the UE failing to satisfy the trigger condition;
maintaining the current measurement opportunity for the frequency point to be measured and/or the cell to be measured;
a request to increase the measurement opportunity for the frequency point to be measured and/or the cell to be measured; and
a second parameter of the measurement configuration recommended by the UE, where the original parameter of the measurement configuration is more relaxed than the second parameter (for example, a measurement period corresponding to the original parameter is 5 ms, and a measurement period corresponding to the second parameter may be 3 ms).

Further, in an embodiment of the present disclosure, the method for the UE to determine the correspondence between the determination result and the update request may include at least one of:
obtaining the correspondence included in the configuration information;
determining the correspondence based on the provision of the protocol; and
independently determining, by the UE, the correspondence.

In the step b, a corresponding update request is sent to the network side device based on the correspondence and the determination result.

In an embodiment of the present disclosure, the method for sending the corresponding update request to the network side device based on the correspondence and the determination result may include: when the determination result determined in the step 202 is the UE satisfies the trigger condition, the UE may determine, based on the correspondence, that the update request corresponding to the determination result that “the UE satisfies the trigger condition” is the update request for requesting to reduce the measurement opportunity, so that the UE can send to the network side device the update request for requesting to reduce the measurement opportunity. When the determination result determined in the step 202 is the UE does not satisfy the trigger condition, the UE may determine, based on the correspondence, that the update request corresponding to the determination result that “the UE does not satisfy the trigger condition” is the update request for requesting to increase the measurement opportunity or maintain the current measurement opportunity, so that the UE may send to the network side device the update request for requesting to increase the measurement opportunity or maintain the current measurement opportunity.

In the step 204, information sent by the network side device based on the update request is received.

In an embodiment of the present disclosure, when update requests sent by the UE to the network side device are different, content of the information sent by the network side device that is received by the UE is also different.

Specifically, in an embodiment of the present disclosure, when the UE sends to the network side device the update request for requesting to reduce the measurement opportunity, the information sent, based on the update request for requesting to reduce the measurement opportunity by the network side device which is received by the UE may include at least one of:
a reconfigured first measurement configuration, where the first measurement configuration is more relaxed than the original measurement configuration (for example, a measurement period of the original measurement configuration is 5 ms, then a measurement period of the first measurement configuration may be 20 ms);
a message to stop measurement;
a first new parameter corresponding to at least one measurement configuration in the original measurement configuration, where the first new parameter is more relaxed than the original parameter corresponding to the measurement configuration (for example, an original parameter corresponding to a measurement frequency in the original measurement configuration includes 3 megahertz (GHZ) and 10 GHZ, then the first new parameter may only include 3 GHZ); and
a first adjustment factor corresponding to the at least one measurement configuration in the original measurement configuration, where the first adjustment factor is configured to relax the measurement configuration (for example, the first adjustment factor may be an expansion factor of the measurement period).

When the UE sends to the network side device the update request for requesting to increase the measurement opportunity or to maintain the current measurement opportunity, the information sent, based on the update request for requesting to increase the measurement opportunity or to maintain the current measurement opportunity, by the network side device that is received by the UE may include at least one of:
a message to maintain the original measurement configuration;
a reconfigured second measurement configuration, where the original measurement configuration is more relaxed than the second measurement configuration (for example, a measurement period of the original measurement configuration is 5 ms, then a measurement period of the second measurement configuration may be 3 ms);
a second new parameter corresponding to at least one measurement configuration in the original measurement configuration, where the original parameter corresponding to the measurement configuration is more relaxed than the second new parameter (for example, an original parameter corresponding to a measurement frequency in the original measurement configuration includes 3 GHZ and 10 GHZ, then the second new parameter may only include 3 GHZ, 10 GHZ and 5 GHZ); and
a second adjustment factor corresponding to the at least one measurement configuration in the original measurement configuration, where the second adjustment factor is configured to increase the measurement opportunity (for example, the second adjustment factor may be a reduction factor of the measurement period).

In the step 205, the frequency point to be measured and/or the cell to be measured are measured based on the information.

In an embodiment of the present disclosure, the method for measuring the frequency point to be measured and/or the cell to be measured based on the information may include: measuring the frequency point to be measured and/or the cell to be measured based on the content included in the information.

Further, in an embodiment of the present disclosure, the information sent by the network side device to the UE may further include a valid duration and/or a valid time window. In an embodiment of the present disclosure, the valid duration and/or the valid time window may be specifically configured to indicate “a specific measurement time period in which the UE measures the frequency point to be measured and/or the cell to be measured based on the information sent by the network side device”. In an embodiment of the present disclosure, the UE may specifically measure, within the valid duration and/or the valid time window, the frequency point to be measured and/or the cell to be measured based on the content included in the information sent by the network side device, and measure, beyond the valid duration and/or the valid time window, the frequency point to be measured and/or the cell to be measured based on an original measurement configuration.

It should also be noted that in an embodiment of the present disclosure, when the content included in the information sent by the network side device to the UE is different, measurement manners of the frequency point to be measured and/or the cell to be measured by the UE are also different.

Specifically, in an embodiment of the present disclosure, if the information sent by the network side device to the UE includes the message to stop the measurement, and the validity period is ten minutes since the information sent by the network side device is received, then after receiving the information sent by the network side device, the UE may stop, within the ten minutes since receiving the information sent by the network side device, measuring the frequency point to be measured and/or the cell to be measured, and may restore, beyond the ten minutes since receiving the information sent by the network side device, the measurement for the frequency point to be measured and/or the cell to be measured.

In another embodiment of the present disclosure, if the information sent by the network side device to the UE includes the reconfigured first measurement configuration, and the valid duration is ten minutes since the information sent by the network side device is received, then after receiving the information sent by the network side device, the UE may measure, within the ten minutes since receiving the information sent by the network side device, the frequency point to be measured and/or the cell to be measured based on the reconfigured first measurement configuration, and measure, beyond the ten minutes since receiving the information sent by the network side device, the frequency point to be measured and/or the cell to be measured based on the original measurement configuration.

To sum up, in the method for measuring the reference signal provided in the present disclosure, the UE receives the configuration information sent by the network side device, and the configuration information includes the trigger condition corresponding to the frequency point to be measured and/or the trigger condition corresponding to the cell to be measured, and then the UE sends the update request to the network side device based on the trigger condition, and receives the information sent, based on the update request, by the network side device. Finally, the UE measures the cell the frequency point to be measured and/or the cell to be measured based on the information sent by the network side device. In embodiments of the present disclosure, the UE sending the update request to the network side device based on the trigger condition is specifically: when the UE satisfies the trigger condition (i.e., the UE cannot measure the cell to be measured and/or the frequency point to be measured), the UE sends to the network side device the update request for requesting to reduce the measurement opportunity, so as to reduce the UE's measurement opportunity, which prevents the UE from measuring the cell to be measured and/or the frequency point to be measured that cannot be measured by the UE, thereby reducing the power consumption.

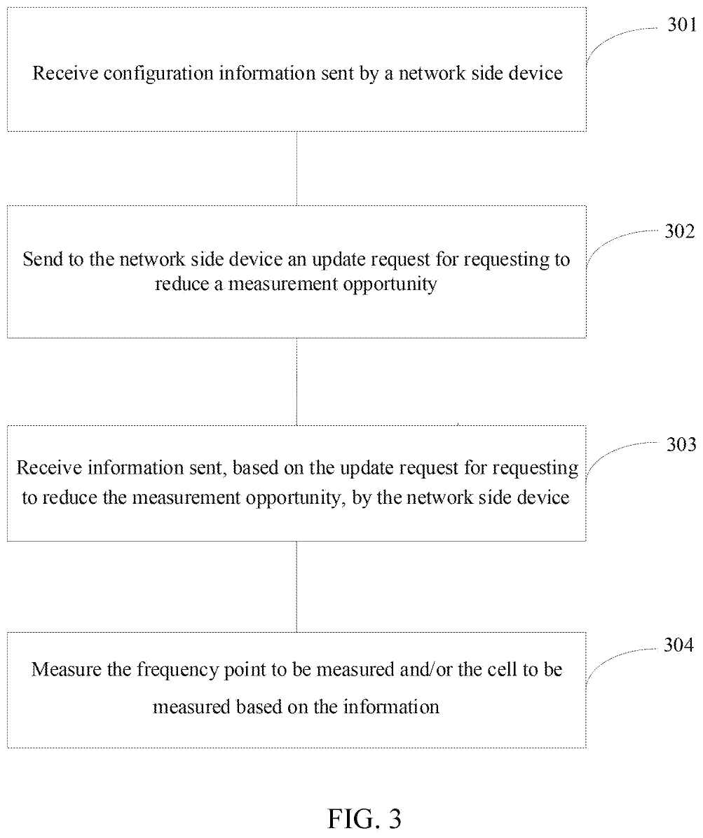

FIG. 3 is a schematic flowchart of a method for measuring a reference signal provided by an embodiment of the present disclosure. The method is performed by a UE. As shown in FIG. 3, the method for measuring the reference signal may include steps 301 to 304.

In the step 301, configuration information sent by a network side device is received, and the configuration information includes a trigger condition corresponding to a frequency point to be measured and/or a trigger condition corresponding to a cell to be measured. The trigger condition is configured to trigger an update of a measurement configuration of the frequency point to be measured and/or a measurement configuration of the cell to be measured.

In the step 302, an update request for requesting to reduce a measurement opportunity is sent to the network side device.

In the step 303, information sent by the network side device based on the update request for requesting to reduce the measurement opportunity is received.

In the step 304, the frequency point to be measured and/or the cell to be measured are measured based on the information.

For the detailed introduction to the steps 301 to 304, reference may be made to the description of the above embodiments, which will not be repeated here in embodiments of the present disclosure.

To sum up, in the method for measuring the reference signal provided in the present disclosure, the UE receives the configuration information sent by the network side device, and the configuration information includes the trigger condition corresponding to the frequency point to be measured and/or the trigger condition corresponding to the cell to be measured, and then the UE sends the update request to the network side device based on the trigger condition, and receives the information sent, based on the update request, by the network side device. Finally, the UE measures the cell the frequency point to be measured and/or the cell to be measured based on the information sent by the network side device. In embodiments of the present disclosure, the UE sending the update request to the network side device based on the trigger condition is specifically: when the UE satisfies the trigger condition (i.e., the UE cannot measure the cell to be measured and/or the frequency point to be measured), the UE sends to the network side device the update request for requesting to reduce the measurement opportunity, so as to reduce the UE's measurement opportunity, which prevents the UE from measuring the cell to be measured and/or the frequency point to be measured that cannot be measured by the UE, thereby reducing the power consumption.

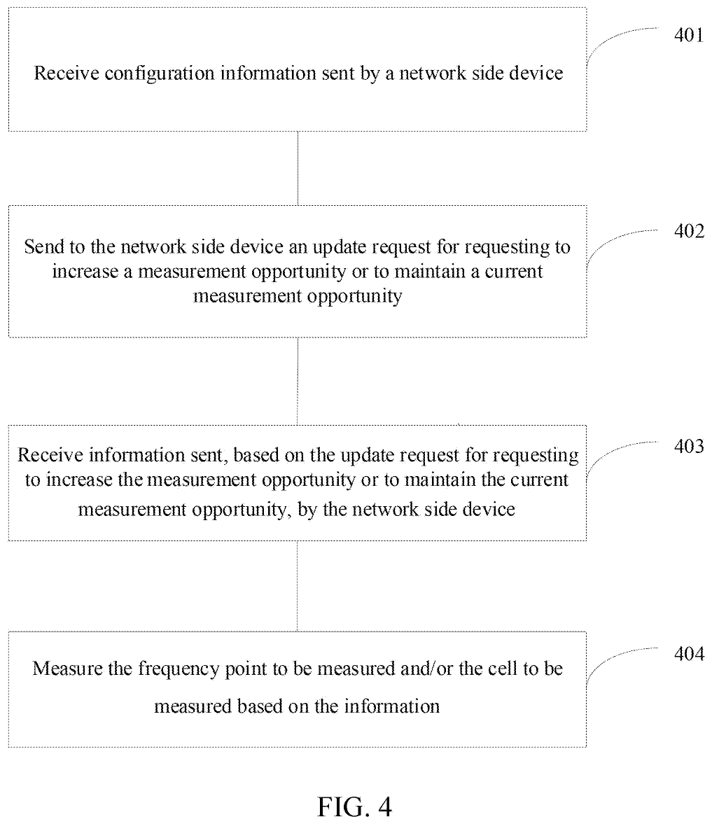

FIG. 4 is a schematic flowchart of a method for measuring a reference signal provided by an embodiment of the present disclosure. The method is performed by a UE. As shown in FIG. 4, the method for measuring the reference signal may include steps 401 to 404.

In the step 401, configuration information sent by a network side device is received, and the configuration information includes a trigger condition corresponding to a frequency point to be measured and/or a trigger condition corresponding to a cell to be measured. The trigger condition is configured to trigger an update of a measurement configuration of the frequency point to be measured and/or a measurement configuration of the cell to be measured.

In the step 402, an update request for requesting to increase a measurement opportunity or to maintain a current measurement opportunity is sent to the network side device.

In the step 403, information sent by the network side device based on the update request for requesting to increase the measurement opportunity or to maintain the current measurement opportunity is received.

In the step 404, the frequency point to be measured and/or the cell to be measured are measured based on the information.

For the detailed introduction to the steps 401 to 404, reference may be made to the description of the above embodiments, which will not be repeated here in embodiments of the present disclosure.

To sum up, in the method for measuring the reference signal provided in the present disclosure, the UE receives the configuration information sent by the network side device, and the configuration information includes the trigger condition corresponding to the frequency point to be measured and/or the trigger condition corresponding to the cell to be measured, and then the UE sends the update request to the network side device based on the trigger condition, and receives the information sent, based on the update request, by the network side device. Finally, the UE measures the cell the frequency point to be measured and/or the cell to be measured based on the information sent by the network side device. In embodiments of the present disclosure, the UE sending the update request to the network side device based on the trigger condition is specifically: when the UE satisfies the trigger condition (i.e., the UE cannot measure the cell to be measured and/or the frequency point to be measured), the UE sends to the network side device the update request for requesting to reduce the measurement opportunity, so as to reduce the UE's measurement opportunity, which prevents the UE from measuring the cell to be measured and/or the frequency point to be measured that cannot be measured by the UE, thereby reducing the power consumption.

In addition, it should be noted that in an embodiment of the present disclosure, the update request may be a displayed update request message. In another embodiment of the present disclosure, the update request may also be an implicit update request message.

In an embodiment of the present disclosure, when the update request is the implicit update request message, the implicit update request message may be derived from other messages sent by the UE to the network. In an embodiment of the present disclosure, the implicit update request message may be derived from a measurement report.

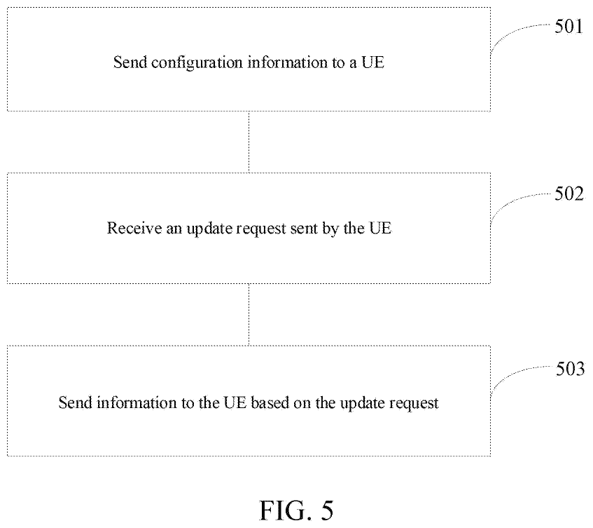

FIG. 5 is a schematic flowchart of a method for measuring a reference signal provided by an embodiment of the present disclosure. The method is performed by a network side device. As shown in FIG. 5, the method for measuring the reference signal may include steps 501 to 503.

In the step 501, configuration information is sent to a UE.

In an embodiment of the present disclosure, the configuration information may specifically include a trigger condition corresponding to a frequency point to be measured and/or a trigger condition corresponding to a cell to be measured. In an embodiment of the present disclosure, the configuration information may only include the trigger condition corresponding to the frequency point to be measured. In another embodiment of the present disclosure, the configuration information may only include the trigger condition corresponding to the cell to be measured. In yet another embodiment of the present disclosure, the configuration information may include the trigger condition corresponding to the cell to be measured and the trigger condition corresponding to the frequency point to be measured.

In an embodiment of the present disclosure, the trigger condition corresponding to the frequency point to be measured may be configured to trigger an update of a measurement configuration of the frequency point to be measured. For example, in an embodiment of the present disclosure, a trigger condition of a frequency point to be measured A may be configured to trigger an update of a measurement configuration of the frequency point A to be measured.

In an embodiment of the present disclosure, the trigger condition corresponding to the cell to be measured may be configured to trigger an update of a measurement configuration of the cell to be measured. For example, in an embodiment of the present disclosure, a trigger condition of a cell to be measured B may be configured to trigger an update of a measurement configuration of the cell to be measured B.

In another embodiment of the present disclosure, the trigger condition corresponding to the frequency point to be measured may be configured to trigger an update of a measurement configuration of another frequency points to be measured. For example, in an embodiment of the present disclosure, the trigger condition of the frequency point to be measured A may be configured to trigger an update of a measurement configuration of a frequency point to be measured C.

In an embodiment of the present disclosure, the trigger condition corresponding to the cell to be measured may be configured to trigger an update of a measurement configuration of another cell to be measured. For example, in an embodiment of the present disclosure, the trigger condition of the cell to be measured B may be configured to trigger an update of a measurement configuration of a cell to be measured D.

It should be noted that in an embodiment of the present disclosure, the other frequency point/cell to be measured may be configured by the network. In another embodiment of the present disclosure, the other frequency point/cell to be measured may also be specified by a protocol. In yet another embodiment of the present disclosure, the other frequency point/cell to be measured may also be determined by the UE.

Further, in an embodiment of the present disclosure, the frequency point/cell to be measured configured by the network may be included in information sent by the network based on an update request (that is, information sent by the network side device to the UE based on the update request in the subsequent step 503).

In an embodiment of the present disclosure, the trigger condition corresponding to the frequency point to be measured may be configured to trigger an update of a measurement configuration of the frequency point to be measured, and the trigger condition corresponding to the cell to be measured may be configured to trigger an update of a measurement configuration of the cell to be measured.

In an embodiment of the present disclosure, the frequency point to be measured may be a frequency point corresponding to any cell, and the cell to be measured may be any cell. For example, in an embodiment of the present disclosure, the frequency point to be measured may be a frequency point corresponding to a TN cell in a NTN cell, and the cell to be measured may be the TN cell in the NTN cell.

Further, in an embodiment of the present disclosure, the trigger condition corresponding to the cell to be measured may include at least one of:
the UE failing to detect a measurement reference signal of the cell to be measured;
the UE failing to detect a measurement reference signal of a frequency point corresponding to the cell to be measured;
the UE failing to obtain a measurement result of the cell to be measured; and
the UE measuring that a measurement result of the cell to be measured is less than a first threshold value.

It should be noted that in an embodiment of the present disclosure, the trigger condition corresponding to the cell to be measured may include any of the above items. In another embodiment of the present disclosure, the trigger condition corresponding to the cell to be measured may include a combination of the above any several items.

In an embodiment of the present disclosure, the above any several items may be combined using a logical relationship such as AND, OR, NOT, etc.

In an embodiment of the present disclosure, the trigger condition corresponding to the frequency point to be measured may include at least one of:
the UE failing to detect a measurement reference signal of a cell corresponding to the frequency point to be measured;
the UE failing to detect a measurement reference signal of the frequency point to be measured;
the UE failing to obtain a measurement result of the cell corresponding to the frequency point to be measured;
the UE measuring that a maximum value of a measurement result of the frequency point to be measured is less than a second threshold value;
the UE measuring that a minimum value of a measurement result of the frequency point to be measured is less than a third threshold value; and
the UE measuring that an average value of measurement results of the frequency point to be measured is less than a fourth threshold value.

In an embodiment of the present disclosure, the first threshold value, the second threshold value, the third threshold value and the fourth threshold value may be the same. In another embodiment of the present disclosure, the first threshold value, the second threshold value, the third threshold value and the fourth threshold value may be different.

In an embodiment of the present disclosure, the trigger condition corresponding to the frequency point to be measured may include any of the above items. In another embodiment of the present disclosure, the trigger condition corresponding to the frequency point to be measured may include a combination of the above any several items.

In an embodiment of the present disclosure, the above any several items may be combined by using the logical relationship such as AND, OR, NOT, etc.

In an embodiment of the present disclosure, the measurement reference signal may include but is not limited to one or more of:
a SSB;
a CSI-RS; and
other reference signals that can be used for the measurement.

In an embodiment of the present disclosure, the measurement result includes but is not limited to one or more of:
a RSRP;
a RSRQ; and
a SINR.

In an embodiment of the present disclosure, the method for the network side device to send the configuration information to the UE may include at least one of:
sending the configuration information to the UE through a system message;
sending the configuration information to the UE through a RRC message;
sending the configuration information to the UE through a MAC CE signaling; and
sending the configuration information to the UE through a DCI signaling.

In the step 502, an update request sent by the UE is received.

In an embodiment of the present disclosure, after receiving the trigger condition in the configuration information sent by the network side device, the UE may determine, based on a predefined determination method, whether the UE satisfies the trigger condition, and send the update request to the network side device based on the determination result. In an embodiment of the present disclosure, the predefined determination method may be indicated by the network side device to the UE.

It should be noted that in an embodiment of the present disclosure, there is a correspondence between the determination result and the update request, and different determination results correspond to sending different update requests. Therefore, when the determination results obtained by the UE are different, the network side device will receive different update requests.

In an embodiment of the present disclosure, the correspondence between the determination result and the update request may include:
when the determination result is that the UE satisfies the trigger condition, it means that the UE is currently unable to detect the cell to be measured and/or the frequency point to be measured (that is, the UE is not within the coverage of the frequency point to be measured and/or the cell to be measured, or the UE is far from the cell to be measured and/or the frequency point to be measured). In this case, the network side device will receive the update request for requesting to reduce the measurement opportunity which is sent by the UE.

When the determination result is that the UE does not satisfy the trigger condition, it means that the UE is able to detect the cell to be measured and/or the frequency point to be measured (that is, the UE is close to the cell to be measured and/or the frequency point to be measured). In this case, the network side device will receive the update request for requesting to increase the measurement opportunity or maintain the current measurement opportunity which is sent by the UE.

In an embodiment of the present disclosure, the correspondence between the determination result and the update request may be carried in the configuration information and sent to the UE by the network side device.

Furthermore, for the detailed introduction to the correspondence between the determination result and the update request, reference may be made to the description of the above embodiments, which will not be described again in embodiments of the present disclosure here.

In the step 503, information is sent to the UE based on the update request.

In an embodiment of the present disclosure, when update requests received by the network side device are different, content of information sent by the network side device to the UE based on the update requests will also vary.

Specifically, in an embodiment of the present disclosure, when the network side device receives the update request for requesting to reduce the measurement opportunity, the content included in the information sent by the network side device to the UE may be content that enables the UE to reduce the measurement opportunity, so as to reduce the measurement opportunity of the UE. In another embodiment of the present disclosure, when the network side device receives the update request for requesting to increase the measurement opportunity or maintain the current measurement opportunity, the content included in the information sent by the network side device to the UE may be content that enables the UE to maintain the current measurement opportunity or increase the measurement opportunity, so as to maintain or increase the measurement opportunity of the UE.

Further, in an embodiment of the present disclosure, the information sent by the network side device to the UE may further include a valid duration and/or a valid time window. In an embodiment of the present disclosure, the valid duration and/or the valid time window may be specifically configured to indicate “a specific measurement time period in which the UE measures the frequency point to be measured and/or the cell to be measured based on the information sent by the network side device”. In an embodiment of the present disclosure, the UE may specifically measure, within the valid duration and/or the valid time window, the frequency point to be measured and/or the cell to be measured based on the content included in the information sent by the network side device, and measure, beyond the valid duration and/or the valid time window, the frequency point to be measured and/or the cell to be measured based on an original measurement configuration.

To sum up, in the method for measuring the reference signal provided in the present disclosure, the UE receives the configuration information sent by the network side device, and the configuration information includes the trigger condition corresponding to the frequency point to be measured and/or the trigger condition corresponding to the cell to be measured, and then the UE sends the update request to the network side device based on the trigger condition, and receives the information sent, based on the update request, by the network side device. Finally, the UE measures the cell the frequency point to be measured and/or the cell to be measured based on the information sent by the network side device. In embodiments of the present disclosure, the UE sending the update request to the network side device based on the trigger condition is specifically: when the UE satisfies the trigger condition (i.e., the UE cannot measure the cell to be measured and/or the frequency point to be measured), the UE sends to the network side device the update request for requesting to reduce the measurement opportunity, so as to reduce the UE's measurement opportunity, which prevents the UE from measuring the cell to be measured and/or the frequency point to be measured that cannot be measured by the UE, thereby reducing the power consumption.

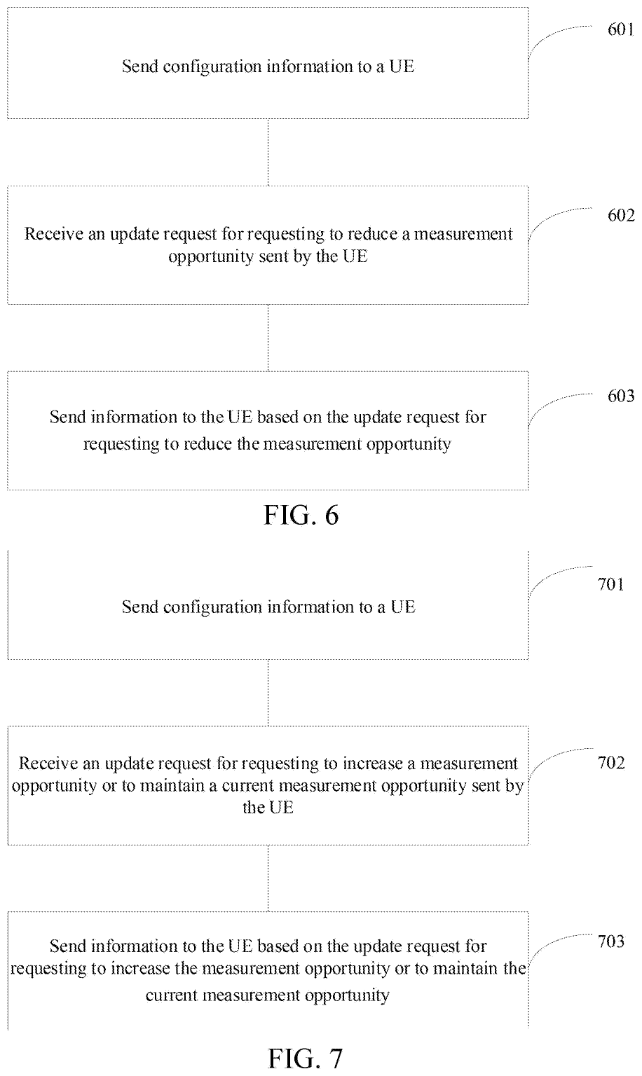

FIG. 6 is a schematic flowchart of a method for measuring a reference signal provided by an embodiment of the present disclosure. The method is performed by a network side device. As shown in FIG. 6, the method for measuring the reference signal may include steps 601 to 603.

In the step 601, configuration information is sent to a UE, the configuration information includes a trigger condition corresponding to a frequency point to be measured and/or a trigger condition corresponding to a cell to be measured, and the trigger condition is configured to trigger an update of a measurement configuration of the frequency point to be measured and/or a measurement configuration of the cell to be measured.

In the step 602, an update request for requesting to reduce a measurement opportunity sent by the UE is received.

In the step 603, information is sent to the UE based on the update request for requesting to reduce the measurement opportunity.

In an embodiment of the present disclosure, the information sent by the network side device to the UE based on the update request for requesting to reduce the measurement opportunity may include at least one of:
a reconfigured first measurement configuration, where the first measurement configuration is more relaxed than an original measurement configuration;
a message to stop measurement;
a first new parameter corresponding to at least one measurement configuration in the original measurement configuration, where the first new parameter is more relaxed than the original parameter corresponding to the measurement configuration; and
a first adjustment factor corresponding to the at least one measurement configuration in the original measurement configuration, where the first adjustment factor is configured to relax the measurement configuration.

For the relevant introduction of the steps 601-603, reference may be made to the introduction of the above embodiments, which will not be described in detail here in embodiments of the present disclosure.

To sum up, in the method for measuring the reference signal provided in the present disclosure, the UE receives the configuration information sent by the network side device, and the configuration information includes the trigger condition corresponding to the frequency point to be measured and/or the trigger condition corresponding to the cell to be measured, and then the UE sends the update request to the network side device based on the trigger condition, and receives the information sent, based on the update request, by the network side device. Finally, the UE measures the cell the frequency point to be measured and/or the cell to be measured based on the information sent by the network side device. In embodiments of the present disclosure, the UE sending the update request to the network side device based on the trigger condition is specifically: when the UE satisfies the trigger condition (i.e., the UE cannot measure the cell to be measured and/or the frequency point to be measured), the UE sends to the network side device the update request for requesting to reduce the measurement opportunity, so as to reduce the UE's measurement opportunity, which prevents the UE from measuring the cell to be measured and/or the frequency point to be measured that cannot be measured by the UE, thereby reducing the power consumption.

FIG. 7 is a schematic flowchart of a method for measuring a reference signal provided by an embodiment of the present disclosure. The method is performed by a network side device. As shown in FIG. 7, the method for measuring the reference signal may include steps 701 to 703.

In the step 701, configuration information is sent to a UE, the configuration information includes a trigger condition corresponding to a frequency point to be measured and/or a trigger condition corresponding to a cell to be measured, and the trigger condition is configured to trigger an update of a measurement configuration of the frequency point to be measured and/or a measurement configuration of the cell to be measured.

In the step 702, an update request for requesting to increase a measurement opportunity or to maintain a current measurement opportunity sent by the UE is received.

In the step 703, information is sent to the UE based on the update request.

In an embodiment of the present disclosure, the information sent by the network side device to the UE based on the update request for requesting to increase the measurement opportunity or to maintain the current measurement opportunity may include at least one of:
a message to maintain the original measurement configuration;
a reconfigured second measurement configuration, where the original measurement configuration is more relaxed than the second measurement configuration;
a second new parameter corresponding to at least one measurement configuration in the original measurement configuration, where the original parameter corresponding to the measurement configuration is more relaxed than the second new parameter; and
a second adjustment factor corresponding to the at least one measurement configuration in the original measurement configuration, where the second adjustment factor is configured to increase the measurement opportunity.

For the relevant introduction of the steps 701 to 703, reference may be made to the introduction of the above embodiments, which will not be described in detail here in embodiments of the present disclosure.

To sum up, in the method for measuring the reference signal provided in the present disclosure, the UE receives the configuration information sent by the network side device, and the configuration information includes the trigger condition corresponding to the frequency point to be measured and/or the trigger condition corresponding to the cell to be measured, and then the UE sends the update request to the network side device based on the trigger condition, and receives the information sent, based on the update request, by the network side device. Finally, the UE measures the cell the frequency point to be measured and/or the cell to be measured based on the information sent by the network side device. In embodiments of the present disclosure, the UE sending the update request to the network side device based on the trigger condition is specifically: when the UE satisfies the trigger condition (i.e., the UE cannot measure the cell to be measured and/or the frequency point to be measured), the UE sends to the network side device the update request for requesting to reduce the measurement opportunity, so as to reduce the UE's measurement opportunity, which prevents the UE from measuring the cell to be measured and/or the frequency point to be measured that cannot be measured by the UE, thereby reducing the power consumption.

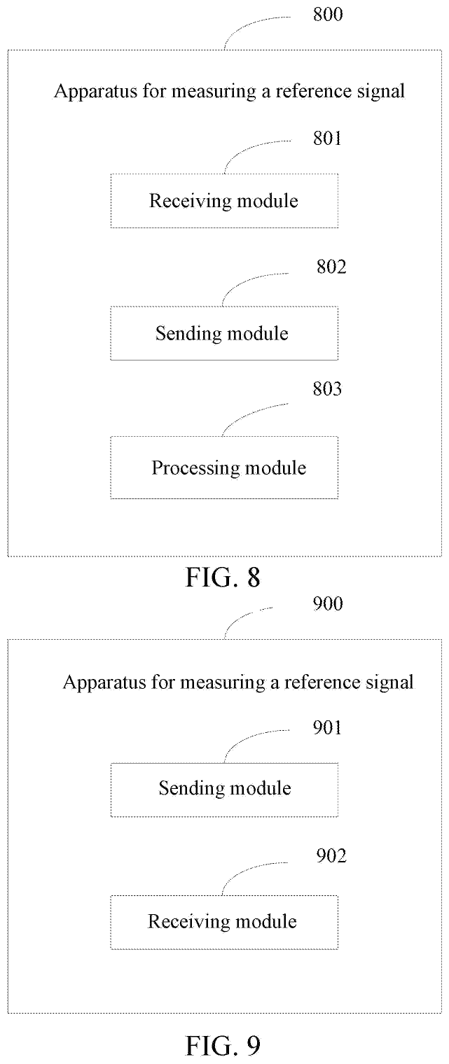

FIG. 8 is a schematic structural diagram of an apparatus for measuring a reference signal provided by an embodiment of the present disclosure. As shown in FIG. 8, the apparatus 800 may include:
a receiving module 801, configured to receive configuration information sent by a network side device, the configuration information includes a trigger condition corresponding to a frequency point to be measured and/or a trigger condition corresponding to a cell to be measured, and the trigger condition is configured to trigger an update of a measurement configuration of the frequency point to be measured and/or a measurement configuration of the cell to be measured;
a sending module 802, configured to send an update request to the network side device based on the trigger condition;
the receiving module 801, further configured to receive information sent, based on the update request, by the network side device; and
a processing module 803, configured to measure the frequency point to be measured and/or the cell to be measured based on the information.

To sum up, in the apparatus for measuring the reference signal provided by embodiments of the present disclosure, the UE may receive the configuration information sent by the network side device including the trigger condition corresponding to the frequency point to be measured and/or the trigger condition corresponding to the cell to be measured, update the corresponding measurement configuration based on the trigger condition and send the update request to the network side device. The UE may receive the message sent, based on the update request, by the network side device, and measure the frequency point to be measured and/or the cell to be measured based on this message. Therefore, the method for measuring the reference signal provided by embodiments of the present disclosure enables the UE to preferentially access a cell with a good signal, ensuring that the UE can stop measurement within the configured time or adopt a new measurement configuration to reduce the power consumption.

In an embodiment of the present disclosure, the trigger condition corresponding to the cell to be measured includes at least one of:
the UE failing to detect a measurement reference signal of the cell to be measured;
the UE failing to detect a measurement reference signal of a frequency point corresponding to the cell to be measured;
the UE failing to obtain a measurement result of the cell to be measured; or
the UE measuring that the measurement result of the cell to be measured is less than a first threshold value.

In an embodiment of the present disclosure, the trigger condition corresponding to the frequency point to be measured includes at least one of:
the UE failing to detect a measurement reference signal of a cell corresponding to the frequency point to be measured;
the UE failing to detect a measurement reference signal of the frequency point to be measured;
the UE failing to obtain a measurement result of the cell corresponding to the frequency point to be measured;
the UE measuring that a maximum value of measurement results of the frequency point to be measured is less than a second threshold value;
the UE measuring that a minimum value of the measurement results of the frequency point to be measured is less than a third threshold value; or
the UE measuring that an average value of the measurement results of the frequency point to be measured is less than a fourth threshold value.

In an embodiment of the present disclosure, the sending module is further configured to:
determine whether the trigger condition is satisfied by the UE; and
send the update request to the network side device based on a determination result.

In an embodiment of the present disclosure, the sending module is further configured to:
determine a predefined determination method to determine whether the trigger condition is satisfied by the UE, and the predefined determination method includes at least one of the following or a combination thereof, that is, a case where the following several cases occur at the same time:
determining whether the trigger condition is satisfied by the UE based on a latest measurement;
determining whether the trigger condition is satisfied by the UE in a measurement within a most recent first duration;
determining whether the trigger condition is satisfied by the UE in a measurement within a first time window;
determining whether the trigger condition is satisfied by the UE in a most recent first quantity of measurements; or
determining whether the trigger condition is satisfied by the UE based on the predefined determination method.

In an embodiment of the present disclosure, the sending module is further configured to:
determine the predefined determination method based on an indication from the network side device;
determine the predefined determination method based on a provision of a protocol; or
independently determine the predefined determination method by the UE.

In an embodiment of the present disclosure, the sending module is further configured to:
determine a correspondence between the determination result and the update request; and
send the corresponding update request to the network side device based on the correspondence and the determination result.

In an embodiment of the present disclosure, the correspondence includes:
when the determination result is that the trigger condition is satisfied by the UE, the UE sends the update request to the network side device, and the update request includes at least one or more of:
the trigger condition being satisfied by the UE;
a request to stop measuring the frequency point to be measured and/or the cell to be measured;
a request to reduce a measurement opportunity for the frequency point to be measured and/or the cell to be measured; or
a first parameter of a measurement configuration recommended by the UE, and the first parameter is more relaxed than an original parameter of the measurement configuration.

In an embodiment of the present disclosure, the correspondence includes:
when the determination result is that the trigger condition is not satisfied by the UE, the UE sends the update request to the network side device, and the update request includes at least one or more of:
the trigger condition being not satisfied by the UE;
maintaining a current measurement opportunity for the frequency point to be measured and/or the cell to be measured;
a request to increase the measurement opportunity for the frequency point to be measured and/or the cell to be measured; or
a second parameter of a measurement configuration recommended by the UE, and an original parameter of the measurement configuration is more relaxed than the second parameter.

In an embodiment of the present disclosure, the sending module is further configured to:
obtain the correspondence included in the configuration information;
determine the correspondence based on a provision of a protocol; or
independently determine the correspondence by the UE.

In an embodiment of the present disclosure, the receiving module is further configured to:
receive at least one piece of the following information sent by the network side device:
a reconfigured first measurement configuration, and the first measurement configuration is more relaxed than an original measurement configuration;
a message to stop measurement;
a first new parameter corresponding to at least one measurement configuration in the original measurement configuration, and the first new parameter is more relaxed than an original parameter corresponding to the measurement configuration; or
a first adjustment factor corresponding to the at least one measurement configuration in the original measurement configuration, and the first adjustment factor is configured to relax the measurement configuration.

In an embodiment of the present disclosure, the receiving module is further configured to:
receive at least one piece of the following information sent by the network side device:
a message to maintain an original measurement configuration;
a reconfigured second measurement configuration, and the original measurement configuration is more relaxed than the second measurement configuration;
a second new parameter corresponding to at least one measurement configuration in the original measurement configuration, and an original parameter corresponding to the measurement configuration is more relaxed than the second new parameter; or
a second adjustment factor corresponding to the at least one measurement configuration in the original measurement configuration, and the second adjustment factor is configured to increase the measurement opportunity.

In an embodiment of the present disclosure, the information sent by the network side device based on the update request further includes a valid duration and/or a valid time window; and
the processing module is further configured to:
measure, within the valid duration and/or the valid time window, the frequency point to be measured and/or the cell to be measured based on content included in the information.

In an embodiment of the present disclosure, the apparatus is further configured to:
measure, beyond the valid duration and/or the valid time window, the frequency point to be measured and/or the cell to be measured based on the original measurement configuration.

FIG. 9 is a schematic structural diagram of an apparatus for measuring a reference signal provided by another embodiment of the present disclosure. As shown in FIG. 9, the apparatus 900 may include:
a sending module 901, configured to send configuration information to a UE, the configuration information includes a trigger condition corresponding to a frequency point to be measured and/or a trigger condition corresponding to a cell to be measured, and the trigger condition is configured to trigger an update of a measurement configuration of the frequency point to be measured and/or a measurement configuration of the cell to be measured;
a receiving module 902, configured to receive an update request sent by the UE; and
the sending module 901, further configured to send information to the UE based on the update request.

To sum up, in the apparatus for measuring the reference signal provided by embodiments of the present disclosure, the UE receives the configuration information sent by the network side device, and the configuration information includes the trigger condition corresponding to the frequency point to be measured and/or the trigger condition corresponding to the cell to be measured, and then the UE sends the update request to the network side device based on the trigger condition, and receives the information sent, based on the update request, by the network side device. Finally, the UE measures the cell the frequency point to be measured and/or the cell to be measured based on the information sent by the network side device. In embodiments of the present disclosure, the UE sending the update request to the network side device based on the trigger condition is specifically: when the UE satisfies the trigger condition (i.e., the UE cannot measure the cell to be measured and/or the frequency point to be measured), the UE sends to the network side device the update request for requesting to reduce the measurement opportunity, so as to reduce the UE's measurement opportunity, which prevents the UE from measuring the cell to be measured and/or the frequency point to be measured that cannot be measured by the UE, thereby reducing the power consumption.

In an embodiment of the present disclosure, the trigger condition corresponding to the cell to be measured includes at least one of:
the UE failing to detect a measurement reference signal of the cell to be measured;
the UE failing to detect a measurement reference signal of a frequency point corresponding to the cell to be measured;
the UE failing to obtain a measurement result of the cell to be measured; or
the UE measuring that the measurement result of the cell to be measured is less than a first threshold value.

In an embodiment of the present disclosure, the trigger condition corresponding to the frequency point to be measured includes at least one of:
the UE failing to detect a measurement reference signal of a cell corresponding to the frequency point to be measured;
the UE failing to detect a measurement reference signal of the frequency point to be measured;
the UE failing to obtain a measurement result of the cell corresponding to the frequency point to be measured;
the UE measuring that a maximum value of measurement results of the frequency point to be measured is less than a second threshold value;
the UE measuring that a minimum value of the measurement results of the frequency point to be measured is less than a third threshold value; or
the UE measuring that an average value of the measurement results of the frequency point to be measured is less than a fourth threshold value.
   In an embodiment of the present disclosure,

In an embodiment of the present disclosure, the apparatus is further configured to:
send to the UE a predefined determination method configured to determine whether the trigger condition is satisfied by the UE;
the predefined determination method includes at least one or more of:
determining whether the trigger condition is satisfied by the UE based on a latest measurement;
determining whether the trigger condition is satisfied by the UE in a measurement within a most recent first duration;
determining whether the trigger condition is satisfied by the UE in a measurement within a first time window; or
determining whether the trigger condition is satisfied by the UE in a most recent first quantity of measurements.

In an embodiment of the present disclosure, the apparatus is further configured to:
send to the UE a correspondence between a determination result and the update request, and the determination result includes a determination result of whether the trigger condition is satisfied by the UE.

In an embodiment of the present disclosure, the correspondence includes:
when the determination result is that the trigger condition is satisfied by the UE, the update request is sent by the UE to the network side device, and the update request includes at least one of:
the trigger condition being satisfied by the UE;
a request to stop measuring the frequency point to be measured and/or the cell to be measured;
a request to reduce a measurement opportunity for the frequency point to be measured and/or the cell to be measured; or
a first parameter of a measurement configuration recommended by the UE, and the first parameter is more relaxed than an original parameter of the measurement configuration.

In an embodiment of the present disclosure, the correspondence includes:
when the determination result is that the trigger condition is not satisfied by the UE, the update request is sent by the UE to the network side device, and the update request includes at least one of:
the trigger condition being not satisfied by the UE;
maintaining a current measurement opportunity for the frequency point to be measured and/or the cell to be measured;
a request to increase the measurement opportunity for the frequency point to be measured and/or the cell to be measured; or
a second parameter of a measurement configuration recommended by the UE, and an original parameter of the measurement configuration is more relaxed than the second parameter.

In an embodiment of the present disclosure, the sending module is further configured to:
send to the UE at least one of:
a reconfigured first measurement configuration, and the first measurement configuration is more relaxed than an original measurement configuration;
a message to stop measurement;
a first new parameter corresponding to at least one measurement configuration in the original measurement configuration, and the first new parameter is more relaxed than an original parameter corresponding to the measurement configuration; or
a first adjustment factor corresponding to the at least one measurement configuration in the original measurement configuration, and the first adjustment factor is configured to relax the measurement configuration.

In an embodiment of the present disclosure, the sending module is further configured to:
send to the UE at least one of:
a message to maintain an original measurement configuration;
a reconfigured second measurement configuration, and the original measurement configuration is more relaxed than the second measurement configuration;
a second new parameter corresponding to at least one measurement configuration in the original measurement configuration, and an original parameter corresponding to the measurement configuration is more relaxed than the second new parameter; or
a second adjustment factor corresponding to the at least one measurement configuration in the original measurement configuration, and the second adjustment factor is configured to increase the measurement opportunity.

In an embodiment of the present disclosure, the information sent by the network side device to the UE further includes a valid duration and/or a valid time window.

In order to implement the above embodiments, the present disclosure further provides a computer program product including a computer program which, when executed by a processor, implements the method shown in any one of FIGS. 1 to 4 or 5 to 7.

In addition, in order to implement the above embodiments, the present disclosure further provides a computer program which, when executed by a processor, implements the method shown in any one of FIGS. 1 to 4 or 5 to 7.

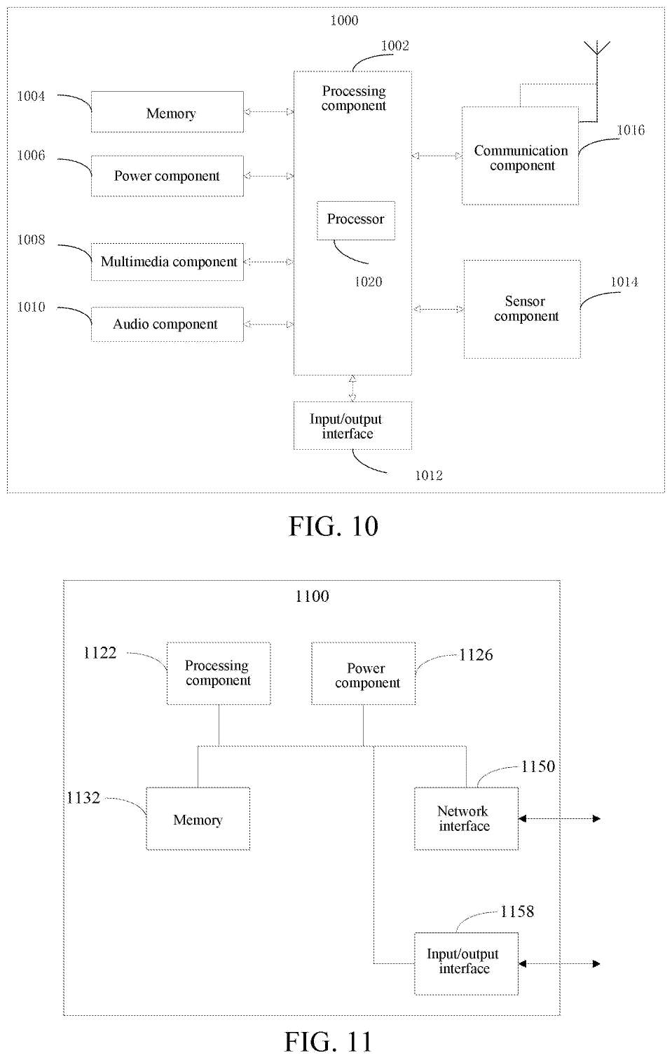

FIG. 10 is a block diagram of a User Equipment (UE) 1000 provided by an embodiment of the present disclosure. For example, the UE 1000 may be a mobile phone, a computer, a digital broadcast terminal device, a messaging device, a gaming console, a tablet, a medical device, an exercise device, a personal digital assistant, etc.

Referring to FIG. 10, the UE 1000 may include at least one of the following components: a processing component 1002, a memory 1004, a power component 1006, a multimedia component 1008, an audio component 1010, an input/output (I/O) interface 1012, a sensor component 1014, and a communication component 1016.

The processing component 1002 typically controls overall operations of the UE 1000, such as the operations associated with display, telephone calls, data communications, camera operations, and recording operations. The processing component 1002 may include at least one processor 1020 to execute instructions to perform all or part of the steps in the above described methods. Moreover, the processing component 1002 may include at least one module which facilitate the interaction between the processing component 1002 and other components. For instance, the processing component 1002 may include a multimedia module to facilitate the interaction between the multimedia component 1008 and the processing component 1002.

The memory 1004 is configured to store various types of data to support the operation of the UE 1000. Examples of such data include instructions for any applications or methods operated on the UE 1000, contact data, phonebook data, messages, pictures, video, etc. The memory 1004 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1006 provides power to various components of the UE 1000. The power component 1006 may include a power management system, at least one power source, and any other components associated with the generation, management, and distribution of power in the UE 1000.

The multimedia component 1008 includes a screen providing an output interface between the UE 1000 and the user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touches, swipes, and gestures on the touch panel. The touch sensors may not only sense a boundary of a touch or swipe action, but also sense a wake-up time and a pressure associated with the touch or swipe action. In some embodiments, the multimedia component 1008 includes a front camera and/or a rear camera. The front camera and the rear camera may receive an external multimedia datum while the UE 1000 is in an operation mode, such as a photographing mode or a video mode. Each of the front camera and the rear camera may be a fixed optical lens system or have focus and optical zoom capability.

The audio component 1010 is configured to output and/or input audio signals. For example, the audio component 1010 includes a microphone (MIC) configured to receive an external audio signal when the UE 1000 is in an operation mode, such as a call mode, a recording mode, and a voice recognition mode. The received audio signal may be further stored in the memory 1004 or transmitted via the communication component 1016. In some embodiments, the audio component 1010 further includes a speaker to output audio signals.

The I/O interface 1012 provides an interface between the processing component 1002 and peripheral interface modules, such as a keyboard, a click wheel, buttons, and the like. The buttons may include, but are not limited to, a home button, a volume button, a starting button, and a locking button.

The sensor component 1014 includes at least one sensor to provide state assessments of various aspects of the UE 1000. For instance, the sensor component 1014 may detect an open/closed state of the UE 1000, relative positioning of components, e.g., the display and the keypad, of the UE 1000, a change in position of the UE 1000 or a component of the UE 1000, a presence or absence of user contact with the UE 1000, an orientation or an acceleration/deceleration of the UE 1000, and a change in temperature of the UE 1000. The sensor component 1014 may include a proximity sensor configured to detect the presence of nearby objects without any physical contact. The sensor component 1014 may further include a light sensor, such as a CMOS or CCD image sensor, for use in imaging applications. In some embodiments, the sensor component 1014 may further include an accelerometer sensor, a gyroscope sensor, a magnetic sensor, a pressure sensor, or a temperature sensor.

The communication component 1016 is configured to facilitate communication, wired or wirelessly, between the UE 1000 and other devices. The UE 1000 may access a wireless network based on a communication standard, such as WiFi, 2G, or 3G, or a combination thereof. In an embodiment, the communication component 1016 receives a broadcast signal or broadcast associated information from an external broadcast management system via a broadcast channel. In an embodiment, the communication component 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the UE 1000 may be implemented with at least one application specific integrated circuit (ASIC), digital signal processor (DSP), digital signal processing device (DSPD), programmable logic device (PLD), field programmable gate array (FPGA), controller, micro-controller, microprocessor, or other electronic components, for performing the above described methods.

FIG. 11 is a block diagram of a network side device 1100 provided by an embodiment of the present disclosure. For example, the network side device 1100 may be provided as a base station. Referring to FIG. 11, the network side device 1100 includes a processing component 1122, which further includes at least one processor and a memory resource represented by a memory 1132 for storing instructions executable by the processing component 1122, such as an application program. The application program stored in the memory 1132 may include one or more modules, each corresponding to a set of instructions. In addition, the processing component 1122 is configured to execute the instructions to execute the aforementioned any method applied on the network side device, for example, the method shown in FIG. 5.

The network side device 1100 may further include: a power component 1126 configured to perform power management of the network side device 1100, a wired or wireless network interface 1150 configured to connect the network side device 1100 to the network, and an input/output (I/O) interface 1158. The network side device 1100 may operate an operating system stored in the memory 1132, such as Windows Server™, Mac OS X™, Unix™, Linux™, FreeBSD™, or the like.

In the above embodiments provided by the present disclosure, the methods provided by embodiments of the present disclosure are introduced from the perspectives of the network side device and the UE. In order to achieve various functions of the methods provided in embodiments of the present disclosure, the network side device and the UE may include hardware structures and software modules, and the various functions are implemented in the form of hardware structures, software modules, or hardware structures plus software modules. One of the various functions may be implemented in the form of hardware structures, software modules, or hardware structure plus software modules.

In the above embodiments provided by the present disclosure, the methods provided by embodiments of the present disclosure are introduced from the perspectives of the network side device and the UE. In order to achieve various functions of the methods provided in embodiments of the present disclosure, the network side device and the UE may include hardware structures and software modules, and the various functions are implemented in the form of hardware structures, software modules, or hardware structures plus software modules. One of the various functions may be implemented in the form of hardware structures, software modules, or hardware structure plus software modules.

Embodiments of the present disclosure provide a communication device. The communication device may include a transceiver module and a processing module. The transceiver module may include a transmitting module and/or a receiving module. The transmitting module is configured to implement a transmission function, and the receiving module is configured to implement a reception function. The transceiver module may implement the transmission function and/or the reception function.

The communication device may be a terminal device (such as the terminal device in the above method embodiments), a device in the terminal device, or a device that can be used in conjunction with the terminal device. Alternatively, the communication device may be a network device, a device in the network device, or a device that can be used in conjunction with the network device.

Embodiments of the present disclosure provide another communication device. The communication device may be a network device, or may be a terminal device (such as the terminal device in the above method embodiments), or may be a chip, a chip system, a processor or the like that supports the network device to implement the above method, or may be a chip, a chip system, a processor or the like that supports the terminal device to implement the above method. The device can be used to implement the method described in the above method embodiments. For details, reference may be made to the description in the above method embodiments.

The communication device may include one or more processors. The processor may be a general-purpose processor or a dedicated processor, or the like. For example, the processor may be a baseband processor or a central processing unit. The baseband processor can be used to process communication protocols and communication data. The central processor can be used to control the communication devices (such as network side devices, baseband chips, terminal devices, terminal device chips, DU or CU, or the like), execute computer programs, and process data for the computer programs.

In embodiments of the present disclosure, the communication device may further include one or more memories, on which a computer program may be stored. The processor executes the computer program, so that the communication device performs the method described in the above method embodiments. In embodiments of the present disclosure, the memory may also store data. The communication device and the memory can be provided separately or integrated together.

In embodiments of the present disclosure, the communication device may further include a transceiver and an antenna. The transceiver may be referred to as a transceiver unit, a transceiver, a transceiver circuit, or the like, and is used to implement transceiver functions. The transceiver may include a receiver and a transmitter. The receiver may be referred to as a receiver or a receiving circuit, or the like, and is used to implement the receiving function; and the transmitter may be referred to as a transmitter, a transmitting circuit, or the like, and is used to implement the transmitting function.

In embodiments of the present disclosure, the communication device may further include one or more interface circuits. The interface circuit is used to receive code instructions and transmit the code instructions to the processor. The processor executes the code instructions to cause the communication device to perform the method described in the above method embodiments.

The communication device is a terminal device (such as the terminal device in the foregoing method embodiments), and the processor is configured to execute the method shown in any one of FIGS. 1-4.

The communication device is a network device, and the transceiver is configured to execute the method shown in any one of FIGS. 5-7.

In an implementation of the present disclosure, the processor may include a transceiver for implementing receiving and transmitting functions. For example, the transceiver may be a transceiver circuit, an interface, or an interface circuit. The transceiver circuits, interfaces or interface circuits used to implement the receiving and transmitting functions can be separate or integrated together. The above-mentioned transceiver circuit, interface or interface circuit can be used for reading and writing codes/data, or the above-mentioned transceiver circuit, interface or interface circuit can be used for signal transmission or transfer.

In an implementation of the present disclosure, the processor may be stored with a computer program, and the computer program is executed by the processor, causing the communication device to perform the method described in the above method embodiments. The computer program may be solidified in the processor, in which case the processor may be implemented by hardware.

In an implementation of the present disclosure, the communication device may include a circuit, and the circuit may implement the functions of sending or receiving or communicating in the foregoing method embodiments. The processors and transceivers described in the present disclosure may be implemented on an integrated circuit (IC), an analog IC, a radio frequency integrated circuit (RFIC), a mixed signal IC, an application specific integrated circuit (ASIC), a printed circuit boards (PCB), an electronic device, and the like. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), and the like.

The communication device described in the above embodiments may be the network device or the terminal device (e.g., the terminal device in the above method embodiments), but the scope of the communication device described in the present disclosure is not limited thereto, and the structure of the communication device may not be limited. The communication device may be a stand-alone device or may be part of a larger device. For example, the communication device may be:
(1) a stand-alone integrated circuit IC, or chip, or chip system or subsystem;
(2) a set of one or more ICs. In embodiments of the present disclosure, the IC set may further include storage components for storing data and computer programs;
(3) an ASIC, such as a modem;
(4) a module that can be embedded in another device;
(5) a receiver, a terminal device, an intelligent terminal device, a cellular phone,
a wireless device, a handheld device, a mobile unit, a vehicle-mounted device, a network device, a cloud device, an artificial intelligence device, and the like;
(6) others, etc.

In a case that the communication device may be a chip or a system on a chip, the chip includes a processor and an interface. The number of processors may be one or more, and the number of interfaces may be multiple.

In an embodiment of the present disclosure, the chip further includes a memory, and the memory is configured to store necessary computer programs and data.

Those skilled in the art can also understand that the various illustrative logical blocks and steps listed in the embodiments of the present disclosure can be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as exceeding the scope of protection of the embodiments of the present disclosure.

Embodiments of the present disclosure further provide a system for measuring a reference signal. The system includes the communication device as the terminal device (such as the terminal device in the above method embodiments) and the communication device as the network device in the above embodiments, or the system includes the communication device as the terminal device (such as the terminal device in the above method embodiments) and the communication device as the network device in the above embodiments.

The present disclosure further provides a readable storage medium on which instructions are stored. When the instructions are executed by a computer, the functions of any of the above method embodiments are implemented.

The present disclosure further provides a computer program product, which, when been executed by a computer, implements the functions of any of the above method embodiments.

In the above embodiments, it may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in accordance with the embodiments of the present disclosure are generated in whole or in part. The computer may be a general-purpose computer, a dedicated computer, a computer network, or other programmable device. The computer program may be stored in a computer-readable storage medium, or been transferred from one computer-readable storage medium to another, for example, the computer program may be transferred from a website, computer, server, or data center to another website, computer, server or data center via wired (such as coaxial cable, optical fiber, digital subscriber line (DSL)) or wireless (such as infrared, wireless, microwave, or the like) means. The computer-readable storage medium may be any available medium that can be accessed by a computer, or a data storage device such as an integrated server, data center, or the like, that includes one or more available media. The available media may be magnetic media (e.g., floppy disks, hard disks, magnetic tapes), optical media (e.g., high-density digital video discs (DVD)), or semiconductor media (e.g., solid state disks, SSD)) or the like.

Those of ordinary skill in the art can understand that the first, second, and other numerical numbers involved in the present disclosure are only distinctions made for convenience of description and are not used to limit the scope of the embodiments of the disclosure, nor to indicate the order.

At least one in the present disclosure can also be described as one or more, and the plurality can be two, three, four or more, which is not limited in the present disclosure. In the embodiment of the present disclosure, for one type of technical feature, “first”, “second”, “third”, “A”, “B”, “C” and “D”, or the like are used to distinguish the technical features in the type of technical feature, and the technical features described with “first”, “second”, “third”, “A”, “B”, “C” and “D” are in no order of precedence or order of size.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for measuring a reference signal, performed by a User Equipment (UE), and comprising:
receiving configuration information sent by a network side device, wherein the configuration information comprises at least one of a trigger condition corresponding to a frequency point to be measured or a trigger condition corresponding to a cell to be measured, the trigger condition corresponding to the frequency point to be measured is configured to trigger an update of a measurement configuration of the frequency point to be measured, and the trigger condition corresponding to the cell to be measured is configured to trigger an update of a measurement configuration of the cell to be measured;
sending an update request to the network side device based on the trigger condition;
receiving information sent, based on the update request, by the network side device; and
measuring at least one of the frequency point to be measured or the cell to be measured based on the information.

2. The method according to claim 1, wherein the trigger condition corresponding to the cell to be measured comprises at least one of:
the UE failing to detect a measurement reference signal of the cell to be measured;
the UE failing to detect a measurement reference signal of a frequency point corresponding to the cell to be measured;
the UE failing to obtain a measurement result of the cell to be measured; or
the UE measuring that the measurement result of the cell to be measured is less than a first threshold value; and
wherein the trigger condition corresponding to the frequency point to be measured comprises at least one of:
the UE failing to detect a measurement reference signal of a cell corresponding to the frequency point to be measured;
the UE failing to detect a measurement reference signal of the frequency point to be measured;
the UE failing to obtain a measurement result of the cell corresponding to the frequency point to be measured;
the UE measuring that a maximum value of measurement results of the frequency point to be measured is less than a second threshold value;
the UE measuring that a minimum value of the measurement results of the frequency point to be measured is less than a third threshold value; or
the UE measuring that an average value of the measurement results of the frequency point to be measured is less than a fourth threshold value.

3. (canceled)

4. The method according to claim 2, wherein the sending the update request to the network side device based on the trigger condition comprises:
determining whether the trigger condition is satisfied by the UE; and
sending the update request to the network side device based on a determination result.

5. The method according to claim 4, wherein the determining whether the trigger condition is satisfied by the UE comprises:
determining whether the trigger condition is satisfied by the UE by determining a predefined determination method, wherein the predefined determination method comprises at least one of:
determining whether the trigger condition is satisfied by the UE based on a latest measurement;
determining whether the trigger condition is satisfied by the UE in a measurement within a most recent first duration;
determining whether the trigger condition is satisfied by the UE in a measurement within a first time window; or
determining whether the trigger condition is satisfied by the UE in a measurement with a most recent first quantity; and
wherein the determining the predefined determination method comprises at least one of:
determining the predefined determination method based on an indication from the network side device;
determining the predefined determination method based on a provision of a protocol; or
independently determining the predefined determination method by the UE.

6. (canceled)

7. The method according to claim 4, wherein the sending the update request to the network side device based on the determination result comprises:
determining a correspondence between the determination result and the update request; and
sending the update request to the network side device based on the correspondence and the determination result, wherein the correspondence comprises at least one of following:
in a case that the determination result is that the trigger condition is satisfied by the UE, the update request comprises at least one of following information:
the trigger condition being satisfied by the UE;
a request to stop measuring at least one of the frequency point to be measured or the cell to be measured;
a request to reduce a measurement opportunity for at least one of the frequency point to be measured or the cell to be measured; or
a first parameter of a measurement configuration recommended by the UE, wherein the first parameter is more relaxed than an original parameter of the measurement configuration, or in a case that the determination result is that the trigger condition is not satisfied by the UE, the update request comprises at least one of following information:
the trigger condition being not satisfied by the UE;
maintaining the measurement opportunity for at least one of the frequency point to be measured or the cell to be measured;
a request to increase the measurement opportunity for at least one of the frequency point to be measured or the cell to be measured; or
a second parameter of the measurement configuration recommended by the UE, wherein the original parameter of the measurement configuration is more relaxed than the second parameter.

8-9. (canceled)

10. The method according to claim 7, wherein the determining the correspondence between the determination result and the update request comprises at least one of:
obtaining the correspondence included in the configuration information;
determining the correspondence based on a provision of a protocol; or
independently determining the correspondence by the UE.

11. The method according to claim 7, wherein in a case that the determination result is that the trigger condition is satisfied by the UE, the receiving the information sent, based on the update request, by the network side device comprises:
receiving at least one of following information sent by the network side device:
a reconfigured first measurement configuration, wherein the first measurement configuration is more relaxed than an original measurement configuration;
a message to stop measurement;
a first new parameter corresponding to at least one measurement configuration in the original measurement configuration, wherein the first new parameter is more relaxed than an original parameter corresponding to the at least one measurement configuration; or
a first adjustment factor corresponding to the at least one measurement configuration in the original measurement configuration, wherein the first adjustment factor is configured to relax the at least one measurement configuration.

12. The method according to claim 7, wherein in a case that the determination result is that the trigger condition is not satisfied by the UE, the receiving the information, based on the update request, sent by the network side device comprises:
receiving at least one of following information sent by the network side device:
a message to maintain an original measurement configuration;
a reconfigured second measurement configuration, wherein the original measurement configuration is more relaxed than the second measurement configuration;
a second new parameter corresponding to at least one measurement configuration in the original measurement configuration, wherein an original parameter corresponding to the at least one measurement configuration is more relaxed than the second new parameter; or
a second adjustment factor corresponding to the at least one measurement configuration in the original measurement configuration, wherein the second adjustment factor is configured to increase the measurement opportunity.

13. The method according to claim 11, wherein the information sent by the network side device based on the update request further comprises at least one of a valid duration or a valid time window; and
the measuring at least one of the frequency point to be measured or the cell to be measured based on the information comprises:
measuring, within at least one of the valid duration or the valid time window, at least one of the frequency point to be measured or the cell to be measured based on the information; and
measuring, beyond at least one of the valid duration or the valid time window, at least one of the frequency point to be measured or the cell to be measured based on the original measurement configuration.

14. (canceled)

15. A method for measuring a reference signal, performed by a network side device, and comprising:
sending configuration information to a User Equipment (UE), wherein the configuration information comprises at least one of a trigger condition corresponding to a frequency point to be measured or a trigger condition corresponding to a cell to be measured, the trigger condition corresponding to the frequency point to be measured is configured to trigger an update of a measurement configuration of the frequency point to be measured or, and the trigger condition corresponding to the cell to be measured is configured to trigger an update of a measurement configuration of the cell to be measured;
receiving an update request sent by the UE; and
sending information to the UE based on the update request.

16. The method according to claim 15, wherein the trigger condition corresponding to the cell to be measured comprises at least one of:
the UE failing to detect a measurement reference signal of the cell to be measured;
the UE failing to detect a measurement reference signal of a frequency point corresponding to the cell to be measured;
the UE failing to obtain a measurement result of the cell to be measured; or
the UE measuring that the measurement result of the cell to be measured is less than a first threshold value; and
wherein the trigger condition corresponding to the frequency point to be measured comprises at least one of:
the UE failing to detect a measurement reference signal of a cell corresponding to the frequency point to be measured;
the UE failing to detect a measurement reference signal of the frequency point to be measured;
the UE failing to obtain a measurement result of the cell corresponding to the frequency point to be measured;
the UE measuring that a maximum value of measurement results of the frequency point to be measured is less than a second threshold value;
the UE measuring that a minimum value of the measurement results of the frequency point to be measured is less than a third threshold value; or
the UE measuring that an average value of the measurement results of the frequency point to be measured is less than a fourth threshold value.

17. (canceled)

18. The method according to claim 16, further comprising:
sending to the UE a predefined determination method configured to determine whether the trigger condition is satisfied by the UE;
wherein the predefined determination method comprises at least one of:
determining whether the trigger condition is satisfied by the UE based on a latest measurement;
determining whether the trigger condition is satisfied by the UE in a measurement within a most recent first duration;
determining whether the trigger condition is satisfied by the UE in a measurement within a first time window; or
determining whether the trigger condition is satisfied by the UE in a measurement with most recent first quantity.

19. The method according to claim 16, further comprising:
sending to the UE a correspondence between a determination result and the update request, wherein the determination result comprises a determination result of whether the trigger condition is satisfied by the UE, wherein the correspondence comprises at least one of following:
in a case that the determination result is that the trigger condition is satisfied by the UE, the update request comprises at least one of:
the trigger condition being satisfied by the UE;
a request to stop measuring at least one of the frequency point to be measured or the cell to be measured;
a request to reduce a measurement opportunity for at least one of the frequency point to be measured or the cell to be measured; or
a first parameter of a measurement configuration recommended by the UE, wherein the first parameter is more relaxed than an original parameter of the measurement configuration, or
in a case that the determination result is that the trigger condition is not satisfied by the UE, the update request comprises at least one of:
the trigger condition being not satisfied by the UE;
maintaining the measurement opportunity for at least one of the frequency point to be measured or the cell to be measured;
a request to increase the measurement opportunity for at least one of the frequency point to be measured or the cell to be measured; or
a second parameter of the measurement configuration recommended by the UE, wherein the original parameter of the measurement configuration is more relaxed than the second parameter.

20-21. (canceled)

22. The method according to claim 19, wherein in a case that the determination result is that the trigger condition is satisfied by the UE, the sending the information to the UE based on the update request comprises:
sending to the UE at least one of following information:
a reconfigured first measurement configuration, wherein the first measurement configuration is more relaxed than an original measurement configuration;
a message to stop measurement;
a first new parameter corresponding to at least one measurement configuration in the original measurement configuration, wherein the first new parameter is more relaxed than an original parameter corresponding to the at least one measurement configuration; or
a first adjustment factor corresponding to the at least one measurement configuration in the original measurement configuration, wherein the first adjustment factor is configured to relax the at least one measurement configuration.

23. The method according to claim 19, wherein in a case that the determination result is that the trigger condition is not satisfied by the UE, the sending the information to the UE based on the update request comprises:
sending to the UE at least one of following information:
a message to maintain an original measurement configuration;
a reconfigured second measurement configuration, wherein the original measurement configuration is more relaxed than the second measurement configuration;
a second new parameter corresponding to at least one measurement configuration in the original measurement configuration, wherein an original parameter corresponding to the at least one measurement configuration is more relaxed than the second new parameter; or
a second adjustment factor corresponding to the at least one measurement configuration in the original measurement configuration, wherein the second adjustment factor is configured to increase the measurement opportunity.

24. The method according to claim 15, wherein the information sent by the network side device to the UE further comprises at least one of a valid duration or a valid time window.

25-26. (canceled)

27. A communication device, comprising a processor and a memory,
wherein a computer program is stored in the memory, and the processor executes the computer program stored in the memory to cause the communication device to execute following acts;
receiving configuration information sent by a network side device, wherein the configuration information comprises at least one of a trigger condition corresponding to a frequency point to be measured or a trigger condition corresponding to a cell to be measured, the trigger condition corresponding to the frequency point to be measured is configured to trigger an update of a measurement configuration of the frequency point to be measured, and the trigger condition corresponding to the cell to be measured is configured to trigger an update of a measurement configuration of the cell to be measured;
sending an update request to the network side device based on the trigger condition;
receiving information sent, based on the update request, by the network side device; and
measuring at least one of the frequency point to be measured or the cell to be measured based on the information.

28. A communication device, comprising a processor and a memory, wherein a computer program is stored in the memory, and the processor executes the computer program stored in the memory to cause the communication device to execute the method according to claim 15.

29-30. (canceled)

31. A non-transitory computer-readable storage medium, configured to store instructions, wherein the instructions, when executed, cause the method according to claim 1 to be implemented.

32. A non-transitory computer-readable storage medium, configured to store instructions, wherein the instructions, when executed, cause the method according to claim 15 to be implemented.
